(19) United States
(12) Patent Application Publication
(10) Pub. No.: US 2022/0027817 A1
(43) Pub. Date: Jan. 27, 2022

(54) DEEP REINFORCEMENT LEARNING FOR PRODUCTION SCHEDULING

(71) Applicant: Dow Global Technologies LLC, Midland, MI (US)

(72) Inventors: Christian Hubbs, Houston, TX (US); John M. Wassick, Midland, MI (US)

(73) Assignee: Dow Global Technologies LLC, Midland, MI (US)

(21) Appl. No.: 17/287,678

(22) PCT Filed: Sep. 26, 2019
(86) PCT No.: PCT/US2019/053315

§ 371 Date: Apr. 22, 2021

Related U.S. Application Data
(60) Provisional application No. 62/750,986, filed on Oct. 26, 2018.

(51) Int. Cl. G06Q 10/06; G06N 3/04; G06N 3/08; G06Q 10/08

(52) U.S. Cl. CPC G06Q 10/06313; G06Q 10/087; G06N 3/084; G06N 3/0472

(57) ABSTRACT

Methods and apparatus for scheduling production at a production facility are provided. A model of a production facility utilizing one or more input materials to produce products that satisfy product requests can be determined. Each product request can specify a requested product to be available at a requested time. Policy and value neural networks can be determined for the production facility. The policy neural network can represent production actions to be scheduled at the production facility and the value neural network can represent benefits of products produced at the production facility. The policy and value neural networks can use the model of the production facility during training for generating a schedule of the production actions at the production facility that satisfy the product requests over an interval of time and relates to penalties due to late production of the requested products.

### CROSS-REFERENCE TO RELATED APPLICATION

This application claims priority to U.S. Provisional Application No. 62/750,986, filed Oct. 26, 2018, which is hereby incorporated herein by reference in its entirety.

### BACKGROUND

Chemical enterprises can use production facilities to convert raw material inputs into products each day. In operating these chemical enterprises, complex questions regarding resource allocation must be asked and answered related to what chemical products should be produced, at what times should those products be produced, and how much production of these products should take place produce. Further questions regarding inventory management, such as how much to dispose of now vs how much to store in inventory and for how long, as “better” answers to these decisions can increase profit margins of the chemical enterprises.

Chemical enterprises are also faced with increased pressure from competition and innovation forcing modifications to production strategies to remain competitive. Moreover, these decisions can be made in the face of significant uncertainty. Production delays, plant shutdowns or stoppages, rush orders, fluctuating prices, and shifting demand can all be sources of uncertainty that render a previously optimal schedule, suboptimal or even infeasible.

Solutions to resource allocation problems faced by chemical enterprises are often computationally difficult, yielding computational times that are too long to react to real-time demands. Scheduling problems are classified by the way they handle time, optimization decisions, and other modeling elements. Two current methods can solve scheduling problems while handling uncertainty: robust optimization and stochastic optimization. Robust optimization ensures a schedule is feasible over a given set of possible outcomes of the uncertainty in the system. An example of robust optimization can involve scheduling a chemical process modeled as a continuous time state-task network (STN) with uncertainty in the processing time, demand, and raw material prices.

Stochastic optimization can deal with uncertainty in stages whereby a decision is made and then uncertainty is revealed which enables a recourse decision to be made given the new information. One stochastic optimization example involves use of a multi-stage stochastic optimization model to determine safety stock levels to maintain a given customer satisfaction level with stochastic demand. Another stochastic optimization example involves use of a two-stage stochastic mixed-integer linear program to address the scheduling of a chemical batch process with a rolling horizon while accounting for the risk associated with their decisions. Although there is a long history of optimization under uncertainty, many techniques are difficult to implement due to high computational costs, sources of uncertainty (endogenous vs exogenous), and complexity in measuring uncertainty.

### SUMMARY

A first example embodiment can involve a computer-implemented method. A model of a production facility that relates to production of one or more products that are produced at the production facility utilizing one or more input materials to satisfy one or more product requests can be determined. Each product request can specify one or more requested products of the one or more products to be available at the production facility at one or more requested times. A policy neural network and a value neural network for the production facility can be determined. The policy neural network can be associated with a policy function representing production actions to be scheduled at the production facility. The value neural network can be associated with a value function representing benefits of products produced at the production facility based on the production actions. The policy neural network and the value neural network can be trained to generate a schedule of the production actions at the production facility that satisfy the one or more product requests over an interval of time based on the model of the production. The schedule of the production actions can relate to penalties due to late production of the one or more requested products determined based on the one or more requested times.

A second example embodiment can involve a computing device. The computing device can include one or more processors and data storage. The data storage can have stored thereon computer-executable instructions that, when executed by the one or more processors, cause the computing device to carry out functions that can include the computer-implemented method of the first example embodiment.

A third example embodiment can involve an article of manufacture. The article of manufacture can include one or more computer readable media having computer-readable instructions stored thereon that, when executed by one or more processors of a computing device, cause the computing device to carry out functions that can include the computer-implemented method of the first example embodiment.

A fourth example embodiment can involve a computing device. The computing device can include: means for carrying out the computer-implemented method of the first example embodiment.

A fifth example embodiment can involve a computer-implemented method. A computing device can receive one or more product requests associated with a production facility, each product request specifying one or more requested products of one or more products to be available at the production facility at one or more requested times. A trained policy neural network and a trained value neural network can be utilized to generate a schedule of production actions at the production facility that satisfy the one or more product requests over an interval of time, the trained policy neural network associated with a policy function representing production actions to be scheduled at the production facility, and the trained value neural network associated with a value function representing benefits of products produced at the production facility based on the production actions, where the schedule of the production actions relates to penalties due to late production of the one or more requested products determined based on the one or more requested times and due to changes in production of the one or more products at the production facility.

A sixth example embodiment can involve a computing device. The computing device can include one or more processors and data storage. The data storage can have stored thereon computer-executable instructions that, when executed by the one or more processors, cause the computing device to carry out functions that can include the computer-implemented method of the fifth example embodiment.

A seventh example embodiment can involve an article of manufacture. The article of manufacture can include one or more computer readable media having computer-readable instructions stored thereon that, when executed by one or more processors of a computing device, cause the computing device to carry out functions that can include the computer-implemented method of the fifth example embodiment.

An eighth example embodiment can involve a computing device. The computing device can include: means for carrying out the computer-implemented method of the fifth example embodiment.

These as well as other embodiments, aspects, advantages, and alternatives will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts an artificial neural network (ANN) architecture, in accordance with example embodiments.

FIGS. 4A and 4B depict training an ANN, in accordance with example embodiments.

FIG. 5 shows a diagram depicting reinforcement learning for ANNs, in accordance with example embodiments.

FIG. 6 depicts an example scheduling problem, in accordance with example embodiments.

FIG. 7 depicts a system including an agent, in accordance with example embodiments.

FIG. 8 is a block diagram of a model for the system of FIG. 7, in accordance with example embodiments.

FIG. 9 depicts a schedule for a production facility in the system of FIG. 7, in accordance with example embodiments.

FIG. 10 is a diagram of an agent of the system of FIG. 7, in accordance with example embodiments.

FIG. 11 shows a diagram illustrating the agent of the system of FIG. 7 generating an action probability distribution, in accordance with example embodiments.

FIG. 12 shows a diagram illustrating the agent of the system of FIG. 7 generating a schedule using action probability distributions, in accordance with example embodiments.

FIG. 13 depicts the schedule of actions of FIG. 12 as being carried out at a particular time, in accordance with example embodiments.

FIG. 13 depicts an example schedule of actions for the production facility of the system of FIG. 7 being carried out at a particular time, in accordance with example embodiments.

FIG. 14 depicts graphs of training rewards per episode and product availability per episode obtained while training the agent of FIG. 7, in accordance with example embodiments.

FIG. 15 depicts graphs comparing neural network and optimization model performance in scheduling activities at a production facility, in accordance with example embodiments.

FIG. 16 depicts additional graphs comparing neural network and optimization model performance in scheduling activities at a production facility, in accordance with example embodiments.

FIG. 17 is a flow chart for a method, in accordance with example embodiments.

FIG. 18 is a flow chart for another method, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

The following embodiments describe architectural and operational aspects of example computing devices and systems that may employ the disclosed ANN implementations, as well as the features and advantages thereof.

Herein are described apparatus and methods for solving production scheduling and planning problems using a computational agent having one or more ANNs trained using deep reinforcement learning. These scheduling and planning problems can involve production scheduling for chemicals produced at a chemical plant; or more generally, products produced at a production facility. Production scheduling in a chemical plant or other production facility can be thought of as repeatedly asking three questions: 1) what products to make? 2) when to make the products? and 3) how much of each product to make? During scheduling and planning, these questions can be asked and answered with respect to minimize cost, maximize profit, minimize makespan (i.e., a time difference between starting and finishing product production), and/or one or more other metrics.

Additional, complex issues can arise during scheduling and planning activities at production facilities—for example, operational stability and customer service are at odds with one another. This is often compounded by uncertainty stemming from demand changes, product reliability, pricing, supply reliability, production quality, maintenance, etc. forcing manufacturers to respond by rescheduling production assets rapidly leading to sub-optimal solutions that can create further difficulties at the production facilities in the future

The result of scheduling and planning can include a schedule of production for future time periods, often 7 or more days in advance, in the face of significant uncertainty surrounding production reliability, demand, and shifting priorities. Additionally, there are multiple constraints and dynamics that are difficult to represent mathematically during scheduling and planning, such as the behavior of certain customers or regional markets the plant must serve. The scheduling and planning process for chemical production can be further complicated by type change restrictions which can produce off-grade material that is sold at a discounted price. Off-grade production itself can be non-deterministic and poor type changes can lead to lengthy production delays and potential shut-downs.

ANNs trained using the herein-described deep reinforcement learning techniques to account for uncertainty and achieve online, dynamic scheduling. The trained ANNs can then be used for production scheduling. For example, a computational agent can embody and use two multi-layer ANNs for scheduling: a value ANN representing a value function for estimating a value of a state of a production facility, where the state is based an inventory of products produced at the production facility (e.g., chemicals produced a chemical plant) and a policy ANN representing a policy function for scheduling production actions at the production facility. Example production actions can include, but are not limited to, actions related to how much of each of chemicals A, B, C . . . to produce at times t1, t2, t3 . . . . The agent can interact with a simulation or model of the production facility to take in information regarding inventory levels, orders, production data, maintenance history, and schedule the plant according to historical demand patterns. The ANNs of the agent can use deep reinforcement learning over a number of simulations to learn how to effectively schedule the production facility in order to meet business requirements. The value and policy ANNs of the agent can readily represent continuous variables, allowing for more generalization through model-free representations, which contrast with model-based methods utilized by prior approaches.

The agent can be trained and, once trained, utilized to schedule production activities at a production facility PF1. To begin a procedure for training and utilizing the agent, a model of production facility PF1 can be obtained. The model can be based on data about PF1 obtained from enterprise resource planning systems and other sources. Then, one or more computing devices can be populated with untrained policy and value ANNs to represent policy and value functions for deep learning. Then, the one or more computing devices can train the policy and value ANNs using deep reinforcement learning algorithms. The training can be based on one or more hyperparameters (e.g., learning rates, step-sizes, discount factors). During training, the policy and value ANNs can interact with the model of production facility PF1 to make relevant decisions based on the model, until a sufficient level of success has been achieved as indicated by an objective function and/or key performance indicators (KPI). Once the sufficient level of success has been achieved on the model, the policy and value ANNs can be considered to be trained to provide production actions for PF1 using the policy ANN and to evaluate the production actions for PF1 using the value ANN.

Then, the trained policy and value ANNs can be optionally copied and/or otherwise moved to one or more computing devices that can act as server(s) associated with operating production facility PF1. Then, the policy and value ANNs can be executed by the one or more computing devices (if the ANNs were not moved) or by the server(s) (if the ANNs were moved) so that the ANNs can react in real-time to changes at production facility PF1. In particular, the policy and value ANNs can determine a schedule of production actions that can be carried out at production facility PF1 to produce one or more products based on one or more input (raw) materials. Production facility PF1 can implement the schedule of production actions through normal processes at PF1. Feedback about the implemented schedule can then be provided to the trained policy and value ANNs and/or the model of production facility PF1 to continue on-going updating and learning.

In addition, one or more KPIs at production facility PF1 (e.g., inventory costs, product values, on-time delivery of product data) can be used to evaluate the trained policy and value ANNs. If the KPIs indicate that the trained policy and value ANNs are not performing adequately, new policy and value ANNs can be trained as described herein, and the newly-trained policy and value ANNs can replace the previous policy and value ANNs.

The herein-described reinforcement learning techniques can dynamically schedule production actions of a production facility, such as single-stage multi-product reactor used for producing chemical products; e.g., various grades of low-density polyethylene (LDPE). The herein-described reinforcement learning techniques provides a natural representation for capturing the uncertainty in a system. Further, these reinforcement learning techniques can be combined with other, existing techniques, such as model-based optimization techniques, to leverage the advantages of both sets of techniques For example, the model-based optimization techniques can be used as an “oracle” during ANN training. Then, a reinforcement learning agent embodying the policy and/or value ANNs could query the oracle when multiple production actions are feasible at a particular time to help select a production action to be scheduled for the particular time. Further, the reinforcement learning agent can learn from the oracle which production actions to take when multiple production actions are feasible over time, thereby reducing (and eventually eliminating) reliance on the oracle. Another possibility for combining reinforcement learning and model-based optimization techniques is to use a reinforcement learning agent to restrict a search space of a stochastic programming algorithm. Once trained, the reinforcement learning agent could assign low probabilities of receiving a high reward to certain actions in order to remove those branches and accelerate the search of the optimization algorithm.

The herein-described reinforcement learning techniques can be used to train ANNs to solve the problem of generating schedules to control a production facility. Schedules produced by the trained ANNs favorably compare to schedules produced by a typical mixed-integer linear programming (MILP) scheduler, where both ANN and MILP scheduling is performed over a number of time intervals on a receding horizon basis. That is, the ANN-generated schedules can achieve higher profitability, lower inventory levels, and better customer service than\deterministic MILP-generated schedules under uncertainty.

Also, the herein-described reinforcement learning techniques can be used to train ANNs to operate with a receding fixed time horizon for planning due to its ability to factor in uncertainty. In addition, a reinforcement learning agent embodying the herein-described trained ANNs can be rapidly executed and continuously available to react in real time to changes at the production facility, enabling the reinforcement learning agent to be flexible and make real-time changes, as necessary, in scheduling production of the production facility.

### I. EXAMPLE COMPUTING DEVICES AND CLOUD-BASED COMPUTING ENVIRONMENTS

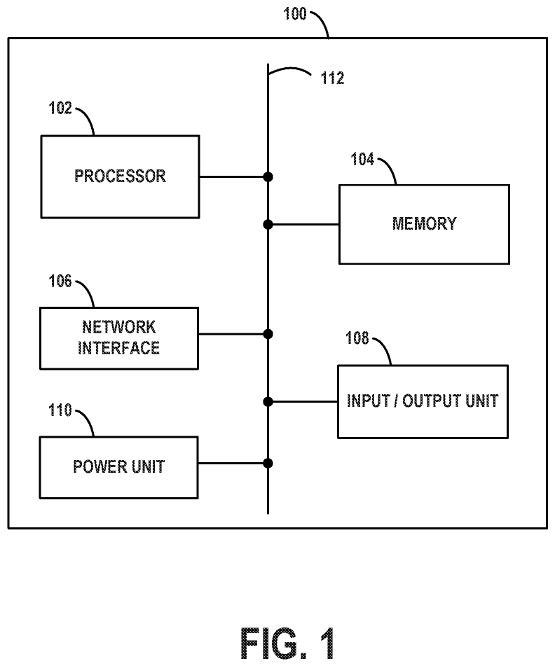

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices can operate as client devices from time to time in order to perform particular operations, and some client devices can incorporate server features.

In this example, computing device 100 includes processor 102, memory 104, network interface 106, an input/output unit 108, and power unit 110, all of which can be coupled by a system bus 112 or a similar mechanism. In some embodiments, computing device 100 can include other components and/or peripheral devices (e.g., detachable storage, printers, and so on).

Processor 102 can be one or more of any type of computer processing element, such as a central processing unit (CPU), a co-processor (e.g., a mathematics, graphics, neural network, or encryption co-processor), a digital signal processor (DSP), an application specific integrated circuit (ASIC), a network processor, and/or a form of integrated circuit or controller that performs processor operations. In some cases, processor 102 can be one or more single-core processors. In other cases, processor 102 can be one or more multi-core processors with multiple independent processing units or “cores”. Processor 102 can also include register memory for temporarily storing instructions being executed and related data, as well as cache memory for temporarily storing recently-used instructions and data.

Memory 104 can be any form of computer-usable memory, including but not limited to random access memory (RAM), read-only memory (ROM), and non-volatile memory. This can include, for example, but not limited to, flash memory, solid state drives, hard disk drives, compact discs (CDs), digital video discs (DVDs), removable magnetic disk media, and tape storage. Computing device 100 can include fixed memory as well as one or more removable memory units, the latter including but not limited to various types of secure digital (SD) cards. Thus, memory 104 represents both main memory units and long-term storage. Other types of memory are possible as well; e.g., biological memory chips.

Memory 104 can store program instructions and/or data on which program instructions can operate. By way of example, memory 104 can store these program instructions on a non-transitory, computer-readable medium, such that the instructions are executable by processor 102 to carry out any of the methods, processes, or operations disclosed in this specification or the accompanying drawings.

In some examples, memory 104 can include software such as firmware, kernel software and/or application software. Firmware can be program code used to boot or otherwise initiate some or all of computing device 100. Kernel software can include an operating system, including modules for memory management, scheduling and management of processes, input/output, and communication. Kernel software can also include device drivers that allow the operating system to communicate with the hardware modules (e.g., memory units, networking interfaces, ports, and busses), of computing device 100. Applications software can be one or more user-space software programs, such as web browsers or email clients, as well as any software libraries used by these programs. Memory 104 can also store data used by these and other programs and applications.

Network interface 106 can take the form of one or more wireline interfaces, such as Ethernet (e.g., Fast Ethernet, Gigabit Ethernet, and so on). Network interface 106 can also support wireline communication over one or more non-Ethernet media, such as coaxial cables, analog subscriber lines, or power lines, or over wide-area media, such as Synchronous Optical Networking (SONET) or digital subscriber line (DSL) technologies. Network interface 106 can additionally take the form of one or more wireless interfaces, such as IEEE 802.11 (Wi-Fi), ZigBee®, BLUETOOTH®, global positioning system (GPS), or a wide-area wireless interface. However, other forms of physical layer interfaces and other types of standard or proprietary communication protocols can be used over network interface 106. Furthermore, network interface 106 can comprise multiple physical interfaces. For instance, some embodiments of computing device 100 can include Ethernet, BLUETOOTH®, ZigBee®, and/or Wi-Fi®, interfaces.

Input/output unit 108 can facilitate user and peripheral device interaction with example computing device 100. Input/output unit 108 can include one or more types of input devices, such as a keyboard, a mouse, a touch screen, and so on. Similarly, input/output unit 108 can include one or more types of output devices, such as a screen, monitor, printer, and/or one or more light emitting diodes (LEDs). Additionally or alternatively, computing device 100 can communicate with other devices using a universal serial bus (USB) or high-definition multimedia interface (HDMI) port interface, for example.

Power unit 110 can include one or more batteries and/or one or more external power interfaces for providing electrical power to computing device 100. Each of the one or more batteries can act as a source of stored electrical power for computing device 100 when electrically coupled to computing device 100. In some examples, some or all of the one or more batteries can be readily removable from computing device 100. In some examples, some or all of the one or more batteries can be internal to computing device 100, and so are not readily removable from computing device 100. In some examples, some or all of the one or more batteries can be rechargeable. In some examples, some or all of one or more batteries can be non-rechargeable batteries. The one or more external power interfaces of power unit 110 can include one or more wired-power interfaces, such as a USB cable and/or a power cord, that enable wired electrical power connections to one or more electrical power supplies that are external to computing device 100. The one or more external power interfaces can include one or more wireless power interfaces (e.g., a Qi wireless charger) that enable wireless electrical power connections, to one or more external power supplies. Once an electrical power connection is established to an external power source using the one or more external power interfaces, computing device 100 can draw electrical power from the external power source using the established electrical power connection. In some examples, power unit 110 can include related sensors; e.g., battery sensors associated with the one or more batteries, electrical power sensors.

In some embodiments, one or more instances of computing device 100 can be deployed to support a clustered architecture. The exact physical location, connectivity, and configuration of these computing devices can be unknown and/or unimportant to client devices. Accordingly, the computing devices can be referred to as “cloud-based” devices that can be housed at various remote data center locations.

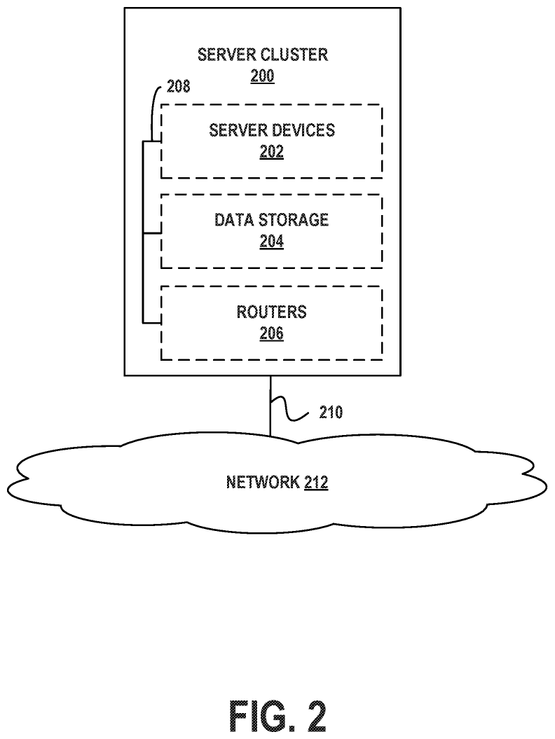

FIG. 2 depicts a cloud-based server cluster 200 in accordance with example embodiments. In FIG. 2, operations of a computing device (e.g., computing device 100) can be distributed between server devices 202, data storage 204, and routers 206, all of which can be connected by local cluster network 208. The amount of server devices 202, data storage 204, and routers 206 in server cluster 200 can depend on the computing task(s) and/or applications assigned to server cluster 200.

For simplicity's sake, both server cluster 200 and individual server devices 202 can be referred to as a “server device.” This nomenclature should be understood to imply that one or more distinct server devices, data storage devices, and cluster routers can be involved in server device operations. In some examples, server devices 202 can be configured to perform various computing tasks of computing device 100. Thus, computing tasks can be distributed among one or more of server devices 202. To the extent that computing tasks can be performed in parallel, such a distribution of tasks can reduce the total time to complete these tasks and return a result.

Data storage 204 can include one or more data storage arrays that include one or more drive array controllers configured to manage read and write access to groups of hard disk drives and/or solid state drives. The drive array controller(s), alone or in conjunction with server devices 202, can also be configured to manage backup or redundant copies of the data stored in data storage 204 to protect against drive failures or other types of failures that prevent one or more of server devices 202 from accessing units of cluster data storage 204. Other types of memory aside from drives can be used.

Routers 206 can include networking equipment configured to provide internal and external communications for server cluster 200. For example, routers 206 can include one or more packet-switching and/or routing devices (including switches and/or gateways) configured to provide (i) network communications between server devices 202 and data storage 204 via cluster network 208, and/or (ii) network communications between the server cluster 200 and other devices via communication link 210 to network 212.

Additionally, the configuration of cluster routers 206 can be based on the data communication requirements of server devices 202 and data storage 204, the latency and throughput of the local cluster network 208, the latency, throughput, and cost of communication link 210, and/or other factors that can contribute to the cost, speed, fault-tolerance, resiliency, efficiency and/or other design goals of the system architecture.

As a possible example, data storage 204 can store any form of database, such as a structured query language (SQL) database. Various types of data structures can store the information in such a database, including but not limited to tables, arrays, lists, trees, and tuples. Furthermore, any databases in data storage 204 can be monolithic or distributed across multiple physical devices.

Server devices 202 can be configured to transmit data to and receive data from cluster data storage 204. This transmission and retrieval can take the form of SQL queries or other types of database queries, and the output of such queries, respectively. Additional text, images, video, and/or audio can be included as well. Furthermore, server devices 202 can organize the received data into web page representations. Such a representation can take the form of a markup language, such as the hypertext markup language (HTML), the extensible markup language (XML), or some other standardized or proprietary format. Moreover, server devices 202 can have the capability of executing various types of computerized scripting languages, such as but not limited to Perl, Python, PHP Hypertext Preprocessor (PHP), Active Server Pages (ASP), JavaScript, and so on. Computer program code written in these languages can facilitate the providing of web pages to client devices, as well as client device interaction with the web pages.

### II. ARTIFICIAL NEURAL NETWORKS

An ANN is a computational model in which a number of simple units, working individually in parallel and without central control, combine to solve complex problems. While this model can resemble an animal's brain in some respects, analogies between ANNs and brains are tenuous at best. Modern ANNs have a fixed structure, a deterministic mathematical learning process, are trained to solve one problem at a time, and are much smaller than their biological counterparts.

A. Example ANN Architecture

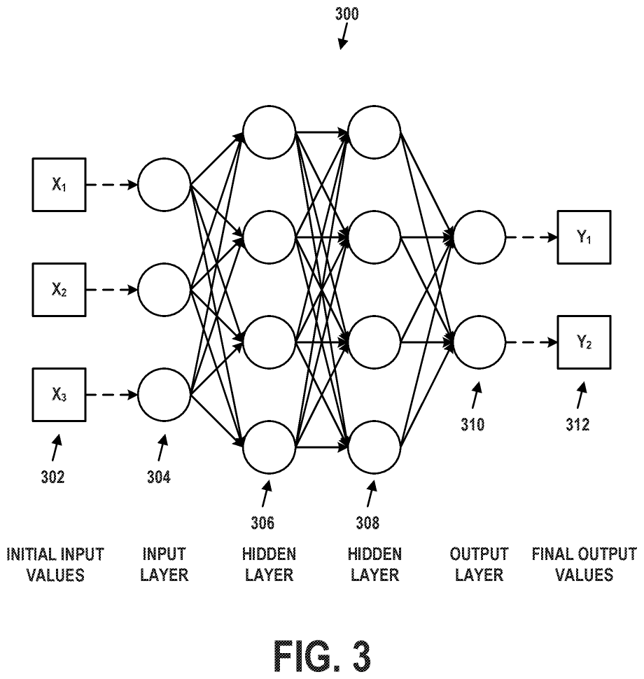

FIG. 3 depicts an ANN architecture, in accordance with example embodiments. An ANN can be represented as a number of nodes that are arranged into a number of layers, with connections between the nodes of adjacent layers. An example ANN 300 is shown in FIG. 3. ANN 300 represents a feed-forward multilayer neural network, but similar structures and principles are used in actor-critic neural networks, convolutional neural networks, recurrent neural networks, and recursive neural networks, for example.

Regardless, ANN 300 consists of four layers: input layer 304, hidden layer 306, hidden layer 308, and output layer 310. Each of the three nodes of input layer 304 respectively receive X₁, X₂, and X₃ from initial input values 302. The two nodes of output layer 310 respectively produce Y₁ and Y₂ for final output values 312. ANN 300 is a fully-connected network, in that nodes of each layer aside from input layer 304 receive input from all nodes in the previous layer.

The solid arrows between pairs of nodes represent connections through which intermediate values flow, and are each associated with a respective weight that is applied to the respective intermediate value. Each node performs an operation on its input values and their associated weights (e.g., values between 0 and 1, inclusive) to produce an output value. In some cases this operation can involve a dot-product sum of the products of each input value and associated weight. An activation function can be applied to the result of the dot-product sum to produce the output value. Other operations are possible.

For example, if a node receives input values {x₁, x₂, . . . , xₙ} on n connections with respective weights of {w₁, w₂, . . . , wₙ}, the dot-product sum d can be determined as:

$$d = {\sum }_{i = 1}^{n} {x}_{i} {w}_{i} + b \qquad ( 1 )$$

where b is a node-specific or layer-specific bias.

Notably, the fully-connected nature of ANN 300 can be used to effectively represent a partially-connected ANN by giving one or more weights a value of 0. Similarly, the bias can also be set to 0 to eliminate the b term.

An activation function, such as the logistic function, can be used to map d to an output value y that is between 0 and 1, inclusive:

$$y = \frac{1}{1 + {e}^{- d}} \qquad ( 2 )$$

Functions other than the logistic function, such as the sigmoid, exponential linear unit (ELU), rectifier linear unit (ReLU) or tanh functions, can be used instead.

Then, y can be used on each of the node's output connections, and will be modified by the respective weights thereof. Particularly, in ANN 300, input values and weights are applied to the nodes of each layer, from left to right until final output values 312 are produced. If ANN 300 has been fully trained, final output values 312 are a proposed solution to the problem that ANN 300 has been trained to solve. In order to obtain a meaningful, useful, and reasonably accurate solution, ANN 300 requires at least some extent of training.

B. Training

Training an ANN usually involves providing the ANN with some form of supervisory training data, namely sets of input values and desired, or ground truth, output values. For ANN 300, this training data can include m sets of input values paired with output values. More formally, the training data can be represented as:

{X_{1,i},X_{2,i},X_{3,i}, [symbol] , [symbol] } (3)

where i=1 . . . m, and [symbol] and [symbol] are the desired output values for the input values of X_{1,i}, X_{2,i}, and X_{3,i}.

The training process involves applying the input values from such a set to ANN 300 and producing associated output values. A loss function is used to evaluate the error between the produced output values and the ground truth output values. This loss function can be a sum of differences, mean squared error, or some other metric. In some cases, error values are determined for all of the m sets, and the error function involves calculating an aggregate (e.g., an average) of these values.

Once the error is determined, the weights on the connections are updated in an attempt to reduce the error. In simple terms, this update process should reward “good” weights and penalize “bad” weights. Thus, the updating should distribute the “blame” for the error through ANN 300 in a fashion that results in a lower error for future iterations of the training data.

The training process continues applying the training data to ANN 300 until the weights converge. Convergence occurs when the error is less than a threshold value or the change in the error is sufficiently small between consecutive iterations of training. At this point, ANN 300 is said to be “trained” and can be applied to new sets of input values in order to predict output values that are unknown.

Most training techniques for ANNs make use of some form of backpropagation. Backpropagation distributes the error one layer at a time, from right to left, through ANN 300. Thus, the weights of the connections between hidden layer 308 and output layer 310 are updated first, the weights of the connections between hidden layer 306 and hidden layer 308 are updated second, and so on. This updating is based on the derivative of the activation function.

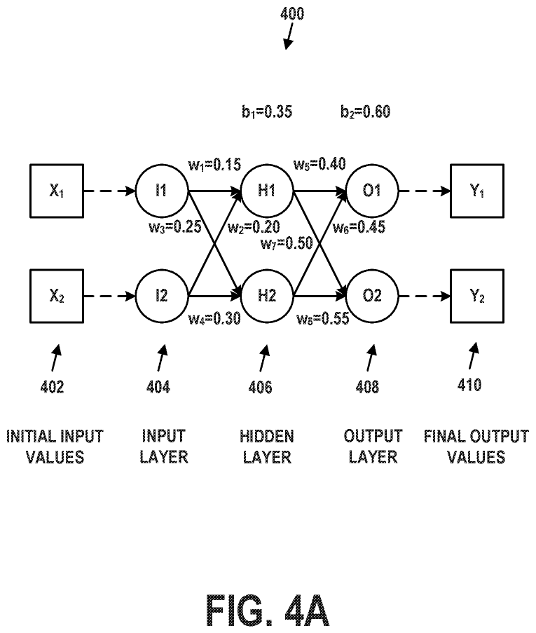

FIGS. 4A and 4B depict training an ANN, in accordance with example embodiments. In order to further explain error determination and backpropagation, it is helpful to look at an example of the process in action. However, backpropagation becomes quite complex to represent except on the simplest of ANNs. Therefore, FIG. 4A introduces a very simple ANN 400 in order to provide an illustrative example of backpropagation.

TABLE 1

| Weight | Nodes |
|---|---|
| w₁ | I1, H1 |
| w₂ | I2, H1 |
| w₃ | I1, H2 |
| w₄ | I2, H2 |
| w₅ | H1, O1 |
| w₆ | H2, O1 |
| w₇ | H1, O2 |
| w₈ | H2, O2 |

ANN 400 consists of three layers, input layer 404, hidden layer 406, and output layer 408, each having two nodes. Initial input values 402 are provided to input layer 404, and output layer 408 produces final output values 410. Weights have been assigned to each of the connections. Also, bias b₁=0.35 is applied to the net input of each node in hidden layer 406, and a bias b₂=0.60 is applied to the net input of each node in output layer 408. For clarity, Table 1 maps weights to pair of nodes with connections to which these weights apply. As an example, w₂ is applied to the connection between nodes I2 and H1, w₇ is applied to the connection between nodes H1 and O2, and so on.

For purposes of demonstration, initial input values are set to X₁=0.05 and X₂=0.10, and the desired output values are set to Ŷ₁=0.01 and Ŷ₂=0.99. Thus, the goal of training ANN 400 is to update the weights over some number of feed forward and backpropagation iterations until the final output values 410 are sufficiently close to Ŷ₁=0.01 and Ŷ₂=0.99 when X₁=0.05 and X₂=0.10. Note that use of a single set of training data effectively trains ANN 400 for just that set. If multiple sets of training data are used, ANN 400 will be trained in accordance with those sets as well.

1. Example Feed Forward Pass

To initiate the feed forward pass, net inputs to each of the nodes in hidden layer 406 are calculated. From the net inputs, the outputs of these nodes can be found by applying the activation function. For node H1, the net input net_{H1} is:

$$\begin{matrix}{net}_{H 1} = {w}_{1} {X}_{1} + {w}_{2} {X}_{2} + {b}_{1} \\ = ( 0.15 ) ( 0.05 ) + ( 0.20 ) ( 0.10 ) + 0.35 = 0.3775\end{matrix} \qquad ( 4 )$$

Applying the activation function (here, the logistic function) to this input determines that the output of node H1, out_{H1} is:

$$\begin{matrix}{out}_{H 1} = \frac{1}{1 + {e}^{- {net}_{H 1}}} \\ = 0.593269992\end{matrix} \qquad ( 5 )$$

Following the same procedure for node H2, the output out_{H2} is 0.596884378. The next step in the feed forward iteration is to perform the same calculations for the nodes of output layer 408. For example, net input to node O1, net_{O1} is:

$$\begin{matrix}{net}_{O 1} = {w}_{5} {out}_{H 1} + {w}_{6} {out}_{H 2} + {b}_{2} \\ = ( 0.40 ) ( 0.593269992 ) + ( 0.45 ) ( 0.596884378 ) + 0.60 \\ = 1.105905967\end{matrix} \qquad ( 6 )$$

Thus, output for node O1, out_{O1} is:

$$\begin{matrix}{out}_{O 1} = \frac{1}{1 + {e}^{- {net}_{O 1}}} \\ = 0.75136507\end{matrix} \qquad ( 7 )$$

Following the same procedure for node O2, the output out_{O2} is 0.772928465. At this point, the total error, Δ, can be determined based on a loss function. In this case, the loss function can be the sum of the squared error for the nodes in output layer 408. In other words:

$$\begin{matrix}Δ = {Δ}_{O 1} + {Δ}_{O 2} \\ = \frac{1}{2} {( {out}_{O 1} - {\hat{Y}}_{1} )}^{2} + \frac{1}{2} {( {out}_{O 2} - {\hat{Y}}_{2} )}^{2} \\ = \frac{1}{2} {( 0.75136507 - 0.01 )}^{2} + \frac{1}{2} {( 0.772928465 - 0.99 )}^{2} \\ = 0.274811083 + 0.023560026 = 0.298371109\end{matrix} \qquad ( 8 )$$

The multiplicative constant ½ in each term is used to simplify differentiation during backpropagation. Since the overall result is scaled by a learning rate anyway, this constant does not negatively impact the training. Regardless, at this point, the feed forward iteration completes and backpropagation begins.

2. Backpropagation

As noted above, a goal of backpropagation is to use Δ to update the weights so that they contribute less error in future feed forward iterations. As an example, consider the weight w₅. The goal involves determining how much the change in w₅ affects Δ. This can be expressed as the partial derivative

$$\frac{\partial Δ}{\partial {w}_{5}} .$$

Using the chain rule, this term can be expanded as:

$$\frac{\partial Δ}{\partial {w}_{5}} = \frac{\partial Δ}{\partial {out}_{O 1}} \times \frac{\partial {out}_{O 1}}{\partial {net}_{O 1}} \times \frac{\partial {net}_{O 1}}{\partial {w}_{5}} \qquad ( 9 )$$

Thus, the effect on Δ of change to w₅ is equivalent to the product of (i) the effect on Δ of change to out_{O1}, (ii) the effect on out_{O1} of change to net_{O1}, and (iii) the effect on net_{O1} of change to w₅. Each of these multiplicative terms can be determined independently. Intuitively, this process can be thought of as isolating the impact of w₅ on net_{O1}, the impact of net_{O1} on out_{O1}, and the impact of out_{O1} on Δ.

Starting with

$$\frac{\partial Δ}{\partial {out}_{O 1}} ,$$

the expression for Δ is:

Δ=½(out_{O1}− [symbol] )²+½(out_{O2}− [symbol] )² (10)

When taking the partial derivative with respect to out_{O1}, the term containing out_{O2} is effectively a constant because changes to out_{O1} do not affect this term. Therefore:

$$\begin{matrix}\frac{\partial Δ}{\partial {out}_{O 1}} = {out}_{O 1} - {\hat{Y}}_{1} \\ = 0.75136507 - 0.01 = 0.74136507\end{matrix} \qquad ( 11 )$$

For

$$\frac{\partial {out}_{O 1}}{\partial {net}_{O 1}} ,$$

the expression for out_{O1}, from Equation 5, is:

$${out}_{O 1} = \frac{1}{1 + {e}^{- {net}_{O 1}}} \qquad ( 12 )$$

Therefore, taking the derivative of the logistic function:

$$\begin{matrix}\frac{\partial {out}_{O 1}}{\partial {net}_{O 1}} = {out}_{O 1} ( 1 - {out}_{O 1} ) \\ = 0.75136507 ( 1 - 0.75136507 ) = 0.186815602\end{matrix} \qquad ( 13 )$$

For

$$\frac{\partial {net}_{O 1}}{\partial {w}_{5}} ,$$

the expression for net_{O1}, from Equation 6, is:

net_{O1}=w₅out_{H1}+w₆out^{H2}+b₂ (14)

Similar to the expression for A, taking the derivative of this expression involves treating the two rightmost terms as constants, since w₅ does not appear in those terms. Tus:

$$\frac{\partial {net}_{O 1}}{\partial {w}_{5}} = {out}_{H 1} = 0.593269992 \qquad ( 15 )$$

These three partial derivative terms can be put together to solve Equation 9:

$$\begin{matrix}\frac{\partial Δ}{\partial {w}_{5}} = ( {out}_{O 1} - ) {out}_{O 1} ( 1 - {out}_{O 1} ) {out}_{H 1} \\ = ( 0.74136507 ) ( 0.186815602 ) ( 0.593269992 ) = 0.082167041\end{matrix} \qquad ( 16 )$$

Then, this value can be subtracted from w₅. Often a gain, 0<α≤1, is applied to

$$\frac{\partial Δ}{\partial {w}_{5}}$$

to control how aggressively the ANN responds to errors. Assuming that α=0.5, the full expression is:

$$\begin{matrix}{w}_{5} = {w}_{5} - α \frac{\partial Δ}{\partial {w}_{5}} \\ = 0.4 - ( 0.5 ) ( 0.082167041 ) = 0.35891648\end{matrix} \qquad ( 17 )$$

This process can be repeated for the other weights feeding into output layer 408. The results are:

w₆=0.408666186

w₇=0.511301270

w₈=0.561370121 (18)

Note that no weights are updated until the updates to all weights have been determined at the end of backpropagation. Then, all weights are updated before the next feed forward iteration.

Next, updates to the remaining weights, w₁, w₂, w₃, and w₄ are calculated. This involves continuing the backpropagation pass to hidden layer 406. Considering w₁ and using a similar derivation as above:

$$\frac{\partial Δ}{\partial {w}_{1}} = \frac{\partial Δ}{\partial {out}_{H 1}} \times \frac{\partial {out}_{H 1}}{\partial {net}_{H 1}} \times \frac{\partial {net}_{H 1}}{\partial {w}_{1}} \qquad ( 19 )$$

One difference, however, between the backpropagation techniques for output layer 408 and hidden layer 406 is that each node in hidden layer 406 contributes to the error of all nodes in output layer 408. Therefore:

$$\frac{\partial Δ}{\partial {out}_{H 1}} = \frac{\partial {Δ}_{O 1}}{\partial {out}_{H 1}} + \frac{\partial {Δ}_{O 2}}{\partial {out}_{H 1}} \qquad ( 20 )$$

Beginning with

$$\frac{\partial Δ}{\partial {out}_{H 1}} \text{:}$$

$$\frac{\partial {Δ}_{O 1}}{\partial {out}_{H 1}} = \frac{\partial {Δ}_{O 1}}{\partial {net}_{O 1}} \times \frac{\partial {net}_{O 1}}{\partial {out}_{H 1}} \qquad ( 21 )$$

Regarding

$$\frac{\partial {Δ}_{O 1}}{\partial {net}_{O 1}} ,$$

the impact of change in net_{O1} on Δ_{O1} is the same as impact of change in net_{O1} on Δ, so the calculations performed above for Equations 11 and 13 can be reused:

$$\frac{\partial {Δ}_{O 1}}{\partial {net}_{O 1}} = \frac{\partial Δ}{\partial {out}_{O 1}} \times \frac{\partial o u {t}_{O 1}}{\partial {net}_{O 1}} = ( 0.74136507 ) ( 0.186815602 ) = 0.138498562 \qquad ( 22 )$$

Regarding

$$\frac{\partial {net}_{O 1}}{\partial {out}_{H 1}} ,$$

net_{O1} can be expressed as:

net_{O1}=w₅out_{H1}+w₆out_{H2}+b₂ (23)

Thus:

$$\frac{\partial {net}_{O 1}}{\partial {out}_{H 1}} = {w}_{5} = 0.40 \qquad ( 24 )$$

Therefore, Equation 21 can be solved as:

$$\frac{\partial {Δ}_{O 1}}{\partial o u {t}_{H 1}} = \frac{\partial {Δ}_{O 1}}{\partial n e {t}_{O 1}} \times \frac{\partial {net}_{O 1}}{\partial o u {t}_{H 1}} = ( 0.138498562 ) ( 0.40 ) = 0.055399425 \qquad ( 25 )$$

Following a similar procedure for

$$\frac{\partial {Δ}_{O 2}}{\partial {out}_{H 1}}$$

results in:

$$\frac{\partial {Δ}_{O 2}}{\partial o u {t}_{H 1}} = - 0.019049119 \qquad ( 26 )$$

Consequently, Equation 20 can be solved as:

$$\frac{\partial Δ}{\partial o u {t}_{H 1}} = \frac{\partial {Δ}_{O 1}}{\partial o u {t}_{H 1}} + \frac{\partial {Δ}_{O 2}}{\partial o u {t}_{H 1}} = 0.055399425 - 0.019049119 = 0.036350306 \qquad ( 27 )$$

This also solves for the first term of Equation 19. Next, since node H1 uses the logistic function as its activation function to relate out_{H1} and net_{N1}, the second term of Equation 19,

$$\frac{\partial {out}_{H 1}}{\partial {net}_{H 1}} ,$$

can be determined as:

$$\frac{\partial o u {t}_{H 1}}{\partial n e {t}_{H 1}} = o u {t}_{H 1} ( 1 - o u {t}_{H 1} ) = 0.59326999 ( 1 - 0.59326999 ) = 0.241300709 \qquad ( 28 )$$

Then, as net_{H1} can be expressed as:

net_{H1}=w₁X₁+w₂X₂+b₁ (29)

Thus, the third term of Equation 19 is:

$$\frac{\partial {net}_{H 1}}{\partial {w}_{1}} = {X}_{1} = 0.05 \qquad ( 30 )$$

Putting the three terms of Equation 19 together, the result is:

$$\frac{\partial Δ}{\partial {w}_{1}} = \frac{\partial Δ}{\partial {out}_{H 1}} \times \frac{\partial o u {t}_{H 1}}{\partial {net}_{H 1}} \times \frac{\partial n e {t}_{H 1}}{\partial {w}_{1}} = ( 0.036350306 ) ( 0.241300709 ) ( 0.05 ) = 0. 00 \; 0438568 \qquad ( 31 )$$

With this, w₁ can be updated as:

$${w}_{1} = {w}_{1} - α \frac{\partial Δ}{\partial {w}_{1}} = 0.15 - ( 0.5 ) ( 0.000438568 ) = 0.149780716 \qquad ( 32 )$$

This process can be repeated for the other weights feeding into hidden layer 406. The results are:

w₂=0.19956143

w₃=0.24975114

w₄=0.29950229 (33)

At this point, the backpropagation iteration is over, and all weights have been updated. FIG. 4B shows ANN 400 with these updated weights, values of which are rounded to four decimal places for sake of convenience. ANN 400 can continue to be trained through subsequent feed forward and backpropagation iterations. For instance, the iteration carried out above reduces the total error, λ, from 0.298371109 to 0.291027924. While this can seem like a small improvement, over several thousand feed forward and backpropagation iterations the error can be reduced to less than 0.0001. At that point, the values of Y₁ and Y₂ will be close to the target values of 0.01 and 0.99, respectively.

In some cases, an equivalent amount of training can be accomplished with fewer iterations if the hyperparameters of the system (e.g., the biases b₁ and b₂ and the learning rate α) are adjusted. For instance, the setting the learning rate closer to 1.0 can result in the error rate being reduced more rapidly. Additionally, the biases can be updated as part of the learning process in a similar fashion to how the weights are updated.

Regardless, ANN 400 is just a simplified example. Arbitrarily complex ANNs can be developed with the number of nodes in each of the input and output layers tuned to address specific problems or goals. Further, more than one hidden layer can be used and any number of nodes can be in each hidden layer.

### III. UTILIZING DEEP REINFORCEMENT LEARNING FOR PRODUCTION SCHEDULING

One way to express uncertainty in a decision problem, such as scheduling production at a production facility, is as a Markov decision process (MDP). A Markov decision process can rely upon the Markov assumption that evolution/changes of future states of an environment are only dependent on a current state of the environment. Formulation as a Markov decision process lends itself to solving the decision problem using machine learning techniques to solve planning and scheduling problems, particularly reinforcement learning techniques.

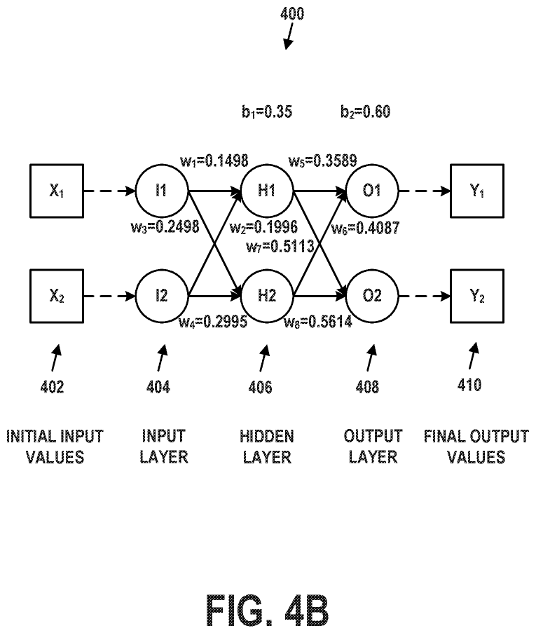

FIG. 5 shows diagram 500 depicting reinforcement learning for ANNs, in accordance with example embodiments. Reinforcement learning utilizes a computational agent which can map “states” of an environment that represents information about the environment into “actions” that can be carried out in an environment to subsequently change the state. The computational agent can repeatedly perform a procedure of receiving state information about the environment, mapping or otherwise determining one or more actions based on the state information, and providing information about the action(s), such as a schedule of actions, to the environment. The actions can then be carried out in the environment to potentially change the environment. Once the actions have been carried out, the computational agent can repeat the procedure after receiving state information about the potentially changed environment.

In diagram 500, the computational agent is shown as agent 510 and the environment is shown as environment 520. In the case of planning and scheduling problems for a production facility in environment 520, agent 510 can embody a scheduling algorithm for the production facility. At time t, agent 510 can receive state Sₜ about environment 520. State Sₜ can include state information, which for environment 520 can include: inventory levels of input materials and products available at the production facility, demand information for products produced by the production facility, one or more existing/previous schedules, and/or additional information relevant to developing a schedule for the production facility

Agent 510 can then map state Sₜ into one or more actions, shown as action Aₜ in FIG. 5. Then, agent 510 can provide action Aₜ to environment 520. Action Aₜ can involve one or more production actions, which can embody scheduling decisions for the production facility (i.e., what to produce, when to produce, how much, etc.). In some examples, action Aₜ can be provided as part of a schedule of actions to be carried out at the production facility over time. Action Aₜ can be carried out by the production facility in environment 520 during time t. To carry out action Aₜ, the production facility can use available input materials to generate products as directed by action Aₜ.

After carrying out action Aₜ, state Sₜ+ of environment 520 at a next time step t+1 can be provided to agent 510. At least while agent 510 is being trained, state Sₜ+i of environment 520 can be accompanied by (or perhaps include) reward Rₜ determined after action Aₜ is carried out; i.e., reward Rₜ is a response to action Aₜ. Reward Rₜ can be one or more scalar values signifying rewards or punishments. Reward Rₜ can be defined by a reward or value function—in some examples, the reward or value function can be equivalent to an objective function in an optimization domain. In the example shown in diagram 500, a reward function can represent an economic value of products produced by the production facility, where a positive reward value can indicate a profit or other favorable economic value, and a negative reward value can indicate a loss or other unfavorable economic value

Agent 510 can interact with environment 520 to learn what actions to provide to environment 520 by self-directed exploration reinforced by rewards and punishments, such as reward Rₜ. That is, agent 510 can be trained to maximize reward Rₜ, where reward Rₜ acts to positively reinforce favorable actions and negatively reinforce unfavorable actions.

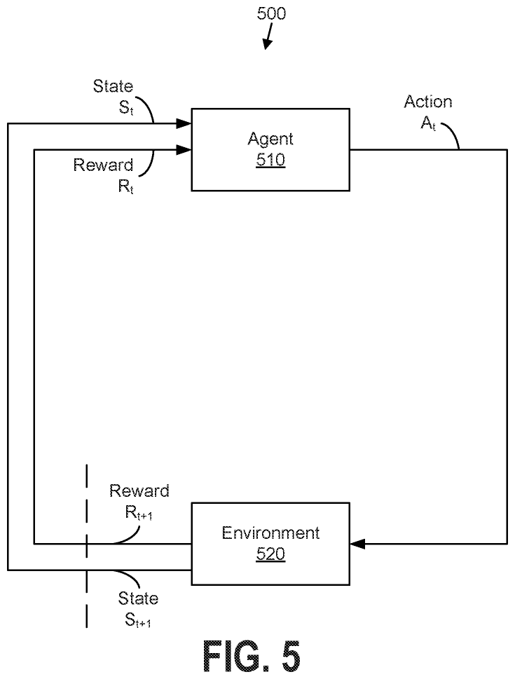

FIG. 6 depicts an example scheduling problem, in accordance with example embodiments. The example scheduling problem involves an agent, such as agent 510, scheduling a production facility to produce one of two products—Product A and Product B—based on incoming product requests. The production facility can only carry out a single product request or order during one unit of time. In this example, the unit of time is a day, so on any given day, the production facility can either produce one unit of Product A or one unit of Product B, and each product request is either a request for one unit of Product A or one unit Product B. In this example, the probability of receiving a product request for product A is a and the probability of receiving a product request for product B is 1−α, where 0≤α≤1.

A reward of +1 is generated for shipment of a correct product and a reward of −1 is generated for shipment of an incorrect product. That is, if a product produced by the production facility for a given day (either Product A or Product B) is the same as a product requested by the product request for the given day, a correct product is produced; otherwise incorrect product is produced. In this example, a correct product is assumed to be delivered from the production facility in accord with the product request and so inventory for correct products does not increase. Also, an incorrect product is assumed not to be delivered from the production facility and so inventory for incorrect products does increase

In this example, a state of the environment is a pair of numbers representing the inventory at the production facility of Products A and B. For example, a state of (8, 6) would indicate the production facility had 8 units of Product A and 6 units of Product A in inventory. In this example, at a time t=0 days, an initial state of the environment/production facility is s₀=(0, 0); that is, no products are in the inventory at the production facility at time t=0.

Graph 600 illustrates transitions from the initial state so at t=0 days to a state s₁ at t=1 day. At state s₀=(0, 0), the agent can take one of two actions: action 602 to schedule production of Product A or action 604 to schedule production of Product B. If the agent takes action 602 to produce Product A, there are one of two possible transitions to state s₁: transition 606a where Product A is requested and the agent receives a reward of +1 since Product A is a correct product, and transition 606b where Product B is requested and the agent receives a reward of −1 since Product B is an incorrect product. Similarly, if the agent takes action 604 to produce Product B, there are one of two possible transitions to state s₁: transition 608a where Product A is requested and the agent receives a reward of −1 since Product A is an incorrect product, and transition 608b where Product B is requested and the agent receives a reward of +1 since Product B is a correct product. As the agent is trying to maximize rewards, positive rewards can act as actual rewards and negative rewards can act as punishments.

Table 610 summarizes the likelihood of the four outcomes possible by transitioning from the initial state s₀ at t=0 days a state s₁ at t=1 day·in this example. A first row of table 610 indicates that if the agent takes action 602 to produce Product A, there is a probability a that the product requested for t=0 days will be Product A. If the product requested for t=0 days is Product A, the agent would receive reward +1 for producing a correct product and the resulting state s₁ at t=1 days would be (0, 0) as correct Product A would be delivered from the production facility.

A second row of table 610 indicates that if the agent takes action 602 to produce Product A, there is a probability 1−α that the product requested for t=0 days will be Product B. If the product requested for t=0 days is Product B, the agent would receive reward −1 for producing an incorrect product and the resulting state s₁ at t=1 days would be (1, 0), as incorrect Product A would remain at the production facility.

A third row of table 610 indicates that if the agent takes action 604 to produce Product B, there is a probability a that the product requested for t=0 days will be Product A. If the product requested for t=0 days is Product A, the agent would receive reward −1 for producing an incorrect product and the resulting state s₁ at t=1 days would be (0, 1), as incorrect Product B would remain at the production facility.

A fourth row of table 610 indicates that if the agent takes action 604 to produce Product B, there is a probability 1−α that the product requested for t=0 days will be Product B. If the product requested for t=0 days is Product B, the agent would receive reward +1 for producing a correct product and the resulting state s₁ at t=1 days would be (0, 0) as correct Product B would be delivered from the production facility.

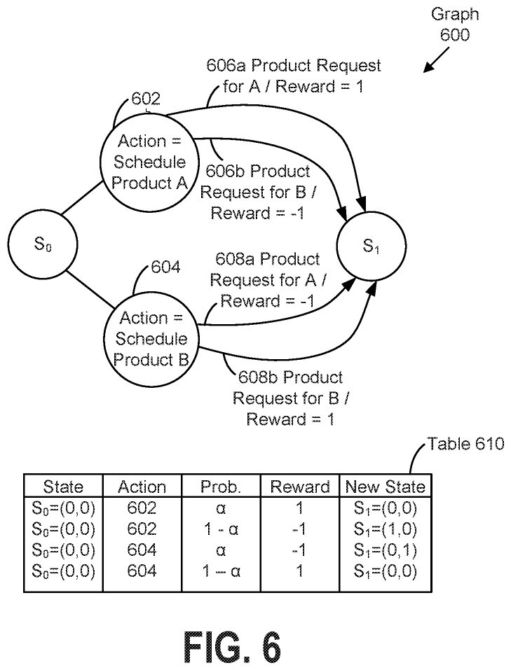

FIG. 7 depicts a system 700 including agent 710, in accordance with example embodiments. Agent 710 can be a computational agent acting to produce schedule 750 for production facility 760 based on various inputs representing a state of an environment represented as production facility 760. The state of production facility 760 can be based on product requests 720 for products produced at production facility 760, product and material inventories information 730, and additional information 740 that can include, but is not limited to, information about manufacturing, equipment status, business intelligence, current market pricing data, and market forecasts. Production facility 760 can receive input materials 762 as inputs to produce products, such as requested products 770. In some examples, agent 710 can include one or more ANNs trained using reinforcement learning to determine actions, represented by schedule 750, based on states of production facility 760 to satisfy product requests 720.

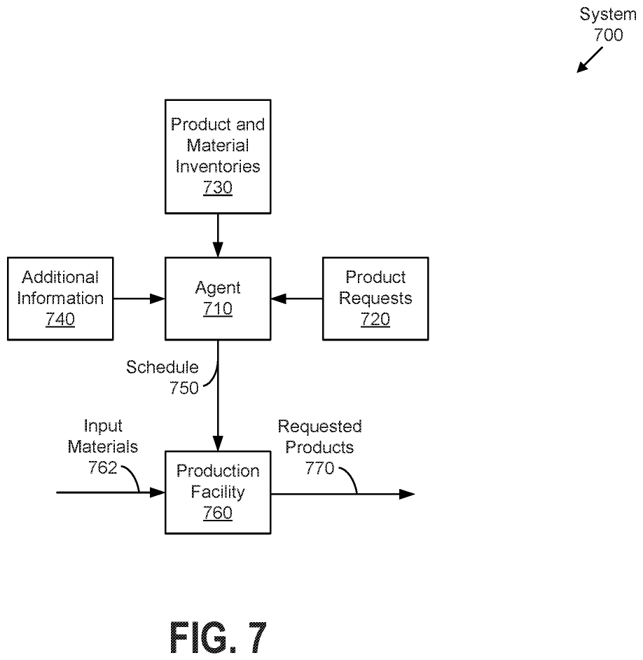

FIG. 8 is a block diagram of a model 800 for system 700, which includes production facility 760, in accordance with example embodiments. Model 800 can represent aspects of system 700, including production facility 760 and product requests 720. In some examples, model 800 can be used by a computational agent, such as agent 710, to model production facility 760 and/or product requests 720. In other examples, model 800 can be used to model production facility 760 and/or product requests 720 for a MILP-based scheduling system.

In this example, model 800 for production facility 760 allows for producing of up to four different grades of LDPE as products 850 using reactor 810, where products 850 are described herein as products Product A, Product B, Product C. and Product D. More particularly, model 800 can represent product requests 720 by an order book of product requests for Products A, B, C, and D, where the order book can be generated according to a fixed statistical profile and can be updated each day with new product requests 720 for that day. For example, the order book can be generated using one or more Monte Carlo techniques based on the fixed statistical profile: i.e., techniques that rely on random numbers/random sampling to generate product requests based on the fixed statistical profile.

Reactor 810 can take fresh input materials 842 and catalysts 844 as inputs to produce products 850. Reactor 810 can also emit recyclable input materials 840 that are passed to compressor 820, which can compress and pass on recyclable input materials 840 to heat exchanger 830. After passing through heat exchanger 830, recyclable input materials 840 can be combined with fresh input materials 842 and provided as input materials to reactor 810.

Reactor 810 can run continuously, but incur type change losses due to type change restrictions and can be subject to uncertainties in demand and equipment availability. Type change losses occur when reactor 810 is directed to make “type changes” or relatively-large changes in processing temperature. Type changes in processing temperature can cause reactor 810 to produce off-grade material—that is, material which is outside product specifications and cannot be sold for as high of a price as prime product, thereby incurring a loss (relative to producing prime product) due to the type change. Such type change losses can range from 2-100%. Type change losses can be minimized by moving to and from product with similar production temperatures and compositions.

Model 800 can include a representation of type change losses by yielding large off-grade production and less than scheduled prime product at each time step where an adverse type change is encountered. Model 800 can also represent a risk of having production facility 760 shut down during an interval of time, at which point schedule 750 will have to be remade de novo with no new products available from the interval of time. Model 800 can also include a representation of late delivery penalties; e.g., a penalty of a predetermined percentage of a price per unit time—example late penalties include but are not limited to a penalty of 3% per day late. 10% per day late. 8% per week late, and 20% per month late. In some examples, model 800 can use other representations of type change losses, production facility risks, late delivery penalties, and/or model other penalties and/or rewards.

In some examples, model 800 can include one or more Monte Carlo techniques to generate states of production facility 760, where each Monte Carlo-generated state of the production facility represents an inventory of products 850 and/or input materials 840, 842 available at the production facility at a specific time; e.g., a Monte Carlo-generated state can represent initial inventory of products 850 and input materials 840, 842, a Monte Carlo-generated state can represent inventory of products 850 and input materials 840, 842 after a particular event, such as a production facility shutdown or production facility restart.

In some examples, model 800 can represent a production facility that has multiple production lines. In some of these examples, the multiple production lines can operate in parallel. In some of these examples, the multiple production lines can include two or more multiple production lines that share at least one common product. In these examples, agent 710 can provide schedules for some, if not all, of the multiple production lines. In some of these examples, agent 710 can provide schedules that take into account operating constraints related to multiple production lines such as, but not limited to: 1) some or all of the production lines can share a common unit operation, resources, and/or operating equipment that prevents these production lines from producing a common product on the same day, 2) some or all of the production lines can share a common utility which limits production on these production lines, and (3) some or all of the production lines can be geographically distributed.

In some examples, model 800 can represent a production facility that is composed of a series of production operations. For example, the production operations can include “upstream” production operations whose products can be stored to be potentially delivered to customers and/or transferred to “downstream” production operations for further processing into additional products. As a more particular example, an upstream production operation can produce products that a downstream packaging line can package in where products are differentiated by packaging used for delivery to customers. In some of these examples, the production operations can be geographically distributed.

In some examples, model 800 can represent a production facility that produces multiple products simultaneously. Agent 710 can then determine schedules indicating how much of each product is produced per time period (e.g., hourly, daily, weekly, every two weeks, monthly, quarterly, annually). In these examples, agent 710 can determine these schedules based on constraints related to amounts, e.g., ratios of amounts, maximum amounts, and/or minimum amounts, of each product produced in a time period and/or by shared resources as may be present in a production facility with multiple production lines.

In some examples, model 800 can represent a production facility that has a combination of: having multiple production lines, being composed of a series of production operations, and/or producing multiple products simultaneously. In some of these examples, upstream production facilities and/or operations can feed downstream facilities and/or operations. In some of these examples, intermediate storage of products can be used between production facilities and/or other production units. In some of these examples, downstream units can produce multiple products at the same time, some of which may represent byproducts that are recycled back to upstream operations for processing. In some of these examples, production facilities and/or operations can be geographically distributed. In these examples, agent 710 can determine production amounts of each product from each operation through time

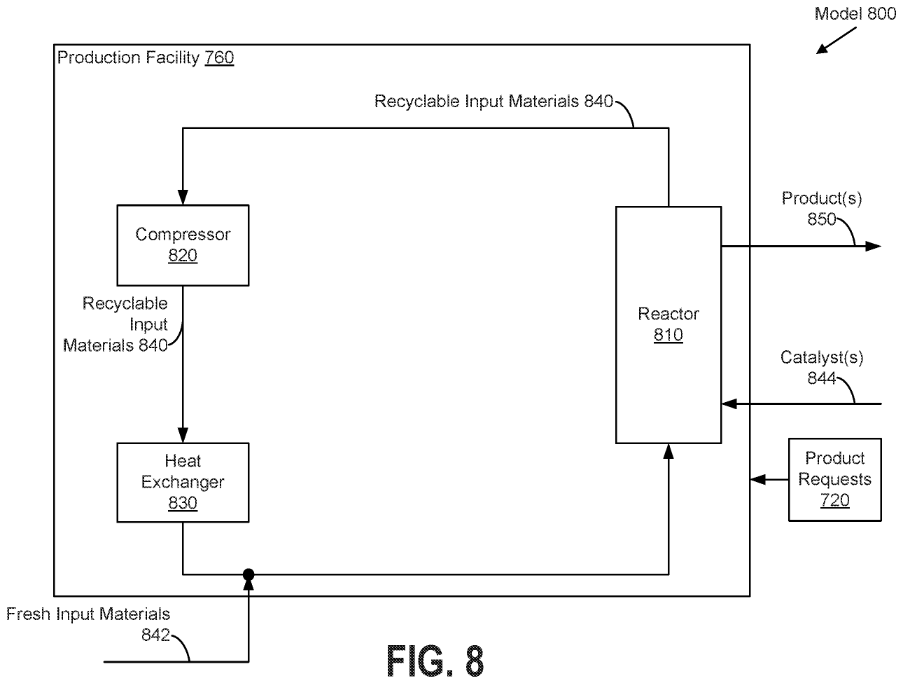

FIG. 9 depicts a schedule 900 for production facility 760 in system 700, in accordance with example embodiments. Schedule 900 is based on a receding “unchangeable” or fixed planning horizon of H=7 days. The unchangeable planning horizon (UPH) of 7 days means that, barring a production stoppage, a schedule cannot change during a 7 day interval. For example, a schedule starting on January 1 with an unchangeable planning horizon of 7 days cannot be altered between January 1 and January 8. Schedule 900 is based on daily (24 hour) time intervals, as products 850 are assumed to have 24 hour production and/or curing times. In the case of a production facility risk leading to a shutdown of production facility 760, schedule 900 would be voided.

FIG. 9 uses a Gantt chart to represent schedule 900, where rows of the Gantt chart represent products of products 850 being produced by production facility 760, and where columns of the Gantt chart represents days of schedule 900. Schedule 900 starts on day 0 and runs until day 16. FIG. 9 shows unchangeable planning horizon 950 of 7 days from day 0 using a vertical dashed unchangeable planning horizon time line 952 at day 7.

Schedule 900 represents production actions for production facility 760 as rectangles. For example, action (A) 910 represents that Product A is to be produced starting on a beginning of day 0 and ending on a beginning of day 1, and action 912 represents that Product A is to be produced starting on a beginning of day 5 and ending on a beginning of day 11; that is, Product A will be produced on day 0 and on days 5-10. Schedule 900 indicates Product B only has one action 920, which indicates Product B will be produced only on day 2. Schedule 900 indicates Product C only has one action 930, which indicates Product C will be produced on days 3 and 4. Schedule 900 indicates Product D has two actions 940, 942—action 940 indicates Product D will be produced on day 1 and action 942 indicates Product D will be produced on days 11-15. Many other schedules for production facility 760 and/or other production facilities are possible as well.

A. Reinforcement Learning Model and the REINFORCE Algorithm

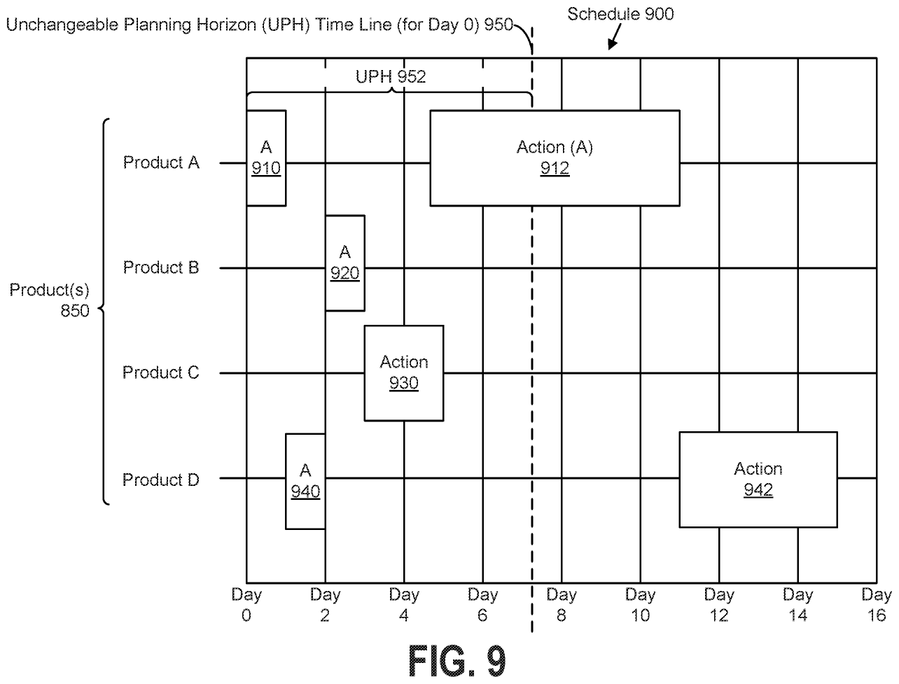

FIG. 10 is a diagram of agent 710 of system 700, in accordance with example embodiments. Agent 710 can embody a neural network model to generate schedules, such as schedule 900, for production facility 760, where the neural network model can be trained and/or otherwise use model 800. In particular, agent 710 can embody a REINFORCE algorithm that can schedule production actions; e.g., scheduling production actions at production facility 760 using model 800 based on an environment state sₜ at a given time step t.

A statement of the REINFORCE algorithm can be found in Table 2 below

```
TABLE 2
Initialize:
  Differentiable policy parameterization π(a | s, θ_{π})
  Differentiable state-value function parameterization \hat{v}(s, θ\hat{ᵥ})
  Select learning rate parameters 0 < α_{π}, α\hat{ᵥ}< 1
Repeat for n ϵ N episodes:
Initialize a new episode:
  Generate new demand, clear schedule and data logs
  Repeat for t ϵ T days in simulation:
    Build new schedule from π and sₜ out to planning horizon:
    aₜ π(aₜ | sₜ, θ_{π})
    Simulate on step forward in time: Get sₜ₊₁ and Rₜ₊₁
    If t ≥ T → End Episode
  Sum up and discount rewards Gₜ using Equation 34.
  Calculate TD-Error (error between predicted and actual rewards)
  δₜ using Equation 35.
  Calculate policy loss L(θ_{π}) using Equation 36.
  Calculate entropy regularization H(π(aₜ | sₜ, θ_{π}) using Equation 37.
  Update weights and biases for θ_{π} using Equation 38.
  Calculate value loss: L(θ\hat{ᵥ}) using Equation 39.
  Update weights and biases for θv using Equation 40.
  If n ≥ N → End Training
```

Equations 34-40 utilized by the REINFORCE algorithm are:

$$\begin{matrix}{G}_{t} = {\sum }_{k = t + 1}^{T} {γ}^{k - t - 1} {R}_{k} ∀ T ∈ T & ( 34 ) \\ {δ}_{t} = {G}_{t} - \hat{v} ( {S}_{t} , {θ}_{\hat{v}} ) ∀ t ∈ T & ( 35 ) \\ L ( {θ}_{π} ) = - \frac{1}{T} {\sum }_{t}^{T} log ( π ( {a}_{t} \vert {s}_{t} , {θ}_{π} ) ) {δ}_{t} & ( 36 ) \\ H ( π ( {a}_{t} \vert {s}_{t} , {θ}_{π} ) ) = - {\sum }_{i} π ( {a}_{t} \vert {s}_{t} , {θ}_{} ) log π ( {a}_{t} \vert {s}_{t} , {θ}_{} ) & ( 37 ) \\ {θ}_{π} : = {θ}_{π} + {α}_{} ( {∇}_{{θ}_{π}} L ( {θ}_{π} ) + β {∇}_{{θ}_{}} H ) & ( 38 ) \\ L ( {θ}_{\hat{v}} ) = \frac{1}{T} {{\sum }^{T}}_{t} {( {\partial }_{t} - {R}_{t} )}^{2} & ( 39 ) \\ {θ}_{\hat{v}} : = {θ}_{\hat{v}} + {α}_{\hat{v}} {∇}_{{θ}_{\hat{v}}} L ( {θ}_{\hat{v}} ) & ( 40 )\end{matrix}$$

FIG. 10 shows agent 710 with ANNs 1000 that include value ANN 1010 and policy ANN 1020. The decision making for the REINFORCE algorithm can be modeled by one or more ANNs, such as value ANN 1010 and policy ANN 1020. In embodying the REINFORCE algorithm, value ANN 1010 and policy ANN 1020 work in tandem. For example, value ANN 1010 can represent a value function for the REINFORCE algorithm that predicts an expected reward of a given state and policy ANN 1020 can represent a policy function for the REINFORCE algorithm that selects one or more actions to be carried out at the given state.

FIG. 10 illustrates that both value ANN 1010 and policy ANN 1020 can have two or more hidden layers and 64 or more nodes for each layer; e.g., four hidden layers with 128 nodes per layer. Value ANN 1010 and/or policy ANN 1020 can use exponential linear unit activation functions and use a softmax (normalized exponential) function in producing output.

Both value ANN 1010 and policy ANN 1020 can receive state sₜ 1030 representing a state of production facility 760 and/or model 800 at a time t. State sₜ 1030 can include an inventory balance for each product of production facility 760 that agent 710 is to make scheduling decisions for at time t. In some examples, negative values in state sₜ 1030 can indicate that there is more demand than expected inventory at production facility 760 at time t, and positive state values in state sₜ 1030 can indicate that there is more expected inventory than demand production facility 760 at time t. In some examples, values in state sₜ1030 are normalized.

Value ANN 1010 can operate on state sₜ 1030 to output one or more value function outputs 1040 and policy ANN 1020 can operate on state sₜ 1030 to output one or more policy function outputs 1050. Value function outputs 1040 can estimate one or more rewards and/or punishments for a taking a production action at production facility 760. Policy function outputs 1050 can include scheduling information for possible production actions A to be taken at production facility 760.

Value ANN 1010 can be updated based on the rewards received for implementing a schedule based on policy function outputs 1050 generated by agent 710 using policy ANN 1020. For example, value ANN 1010 can be updated based on a difference between an actual reward obtained at time t and an estimated reward for time t generated as part of value function outputs 1040.

The REINFORCE algorithm can build a schedule for production facility 760 and/or model 800 using successive forward propagation of state sₜ through policy ANN 1020 over one or more time steps to yield distributions which are sampled at various “episodes” or time intervals (e.g., hourly, every six hours, daily, every two days) to generate a schedule for each episode. For each time step t of the simulation, a reward R is returned as feedback to agent 710 to train on at the end of the episode.

The REINFORCE algorithm can account for an environment moving forward in time throughout the entire episode. At each episode, agent 710 embodying the REINFORCE algorithm can build a schedule based on the state information it receives from the environment at each time step t out to the planning horizon, such as state sₜ 1030. This schedule can be executed at production facility 760 and/or executed in simulation using model 800.

After an episode is completed, Equation 34 updates rewards obtained during an episode. Equation 35 calculates a temporal difference (TD) error between expected rewards and actual rewards. Equation 36 is a loss function for the policy function. To encourage additional exploration, the REINFORCE algorithm can use an entropy term H in a loss function for the policy function, where entropy term H is calculated in Equation 37 and applied by Equation 38 during updates to weights and biases of policy ANN 1020. At the end of the episode, the REINFORCE algorithm of agent 710 can be updated by taking the derivative with respect to a loss function of the value function and updating the weights and biases of value ANN 1010 using a backpropagation algorithm as illustrated by Equations 39 and 40.

Policy ANN 1020 can represent a stochastic policy function that yields a probability distribution over possible actions for each state. The REINFORCE algorithm can use policy ANN 1020 to make decisions during a planning horizon, such as unchangeable planning horizon 950 of schedule 900. During the planning horizon, policy ANN 1020 does not have the benefit of observing new states.

There are at least two options for handling such planning horizons: (1) agent 710 embodying the REINFORCE algorithm and policy ANN 1020 can sample over possible schedules for the planning horizon, or (2) agent 710 can iteratively sample over all products while taking into account a model of the evolution of future states. Option (1) can be difficult to apply to scheduling as the number of possible schedules grows exponentially; thus, the action space explodes as new products are added or the planning horizon is increased. For example, for a production facility with four products and a planning horizon of seven days, there are 16,284 possible schedules to sample from. As such, option (1) can result in making many sample schedules before finding a suitable schedule.

To carry out option (2) during scheduling, agent 710 can predict one or more future states sₜ₊₁, sₜ₊₂ . . . given information available at time t; e.g., state sₜ 1030. Agent 710 can predict future state(s) because repeatedly passing the current state to policy ANN 1020 while building a schedule over time can result in policy ANN 1020 repeatedly providing the same policy function outputs 1050; e.g., repeatedly providing same probability distribution over actions.

To determine a future state sₜ+, agent 710 can use a first principle model with an inventory balance; that is, an inventory of a product p at time t+1, Iᵢₜ₊₁, can be equal to the inventory at time t, Iᵢₜ plus the estimated production of product p at time t, \hat{p}ᵢₜ, minus sales of product p at time t, sᵢₜₗₙ. That i, agent 710 can compute inventory balance Iᵢₜ₊₁=Iᵢₜ+\hat{p}ᵢₜ=sᵢₜₗₙ. This inventory balance estimate Iᵢₜ₊₁ along with data on available product requests (e.g., product requests 720) and/or planned production can provide sufficient data for agent 710 to generate an estimated inventory balance Iᵢₜ₊ for state sₜ₊₁.

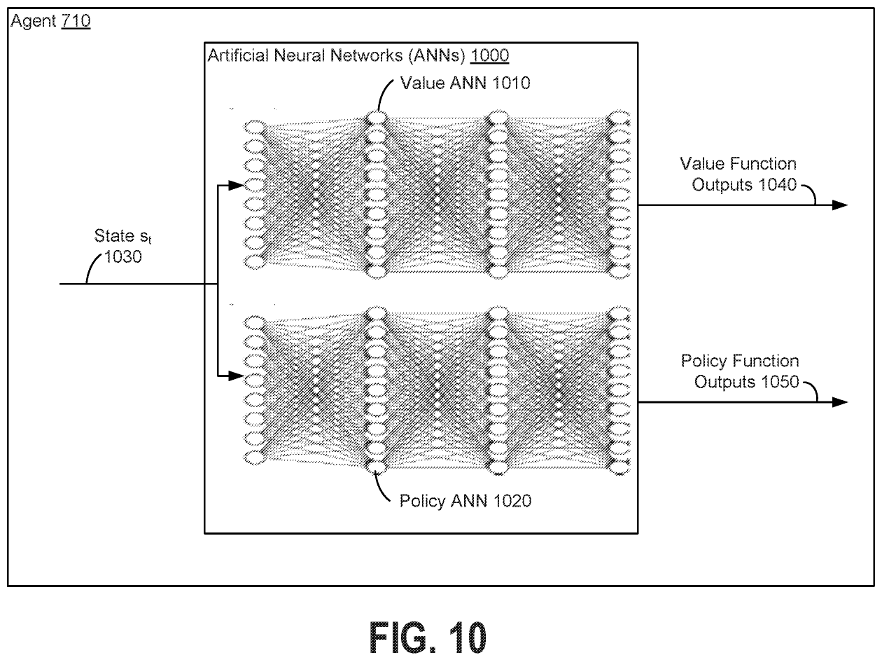

FIG. 11 shows diagram 1100 which illustrates agent 710 generating action probability distribution 1110, in accordance with example embodiments. To generate action probability distribution 1110 as part of policy function outputs 1050, agent 710 can receive can receive state sₜ 1030 and provide state sₜ 1030 to ANNs 1000. Policy ANN 1020 of ANNs 1000 can operate on state sₜ 1030 to provide policy function outputs 1050 for state sₜ.

Diagram 1100 illustrates that policy function outputs 1050 can include one or more probability distributions over a set of possible production actions A to be taken at production facility 760, such as action probability distribution 1110. FIG. 11 shows that action probability distribution 1110 includes probabilities for each of four actions that agent 710 could provide to production facility 760 based on state sₜ 1030. Given state sₜ, policy ANN 1020 indicates that: an action to schedule Product A should be provided to production facility 760 with a probability of 0.8, an action to schedule Product B should be provided to production facility 760 with a probability of 0.05, an action to schedule Product C should be provided to production facility 760 with a probability of 0.1, and an action to schedule Product D should be provided to production facility 760 with a probability of 0.05.

The probability distribution(s) of policy function outputs 1050, such as action probability distribution 1110, can be sampled and/or selected to yield one or more actions for making product(s) at time t in the schedule. In some examples, action probability distribution 1110 can be randomly sampled to obtain one or more actions for the schedule. In some examples, the N (N>0) highest probability production actions a₁, a₂ . . . a_{N} in the probability distribution can be selected to make up to N different products at one time. As a more particular example, if N=1 for sampling action probability distribution 1110, then the highest probability production action is sampled and/or selected—for this example, the highest probability production action is the action of producing product A (having a probability of 0.8), and so an action of producing product A would be added to the schedule for time t. Other techniques for sampling and/or selecting actions from action probability distributions are possible as well.

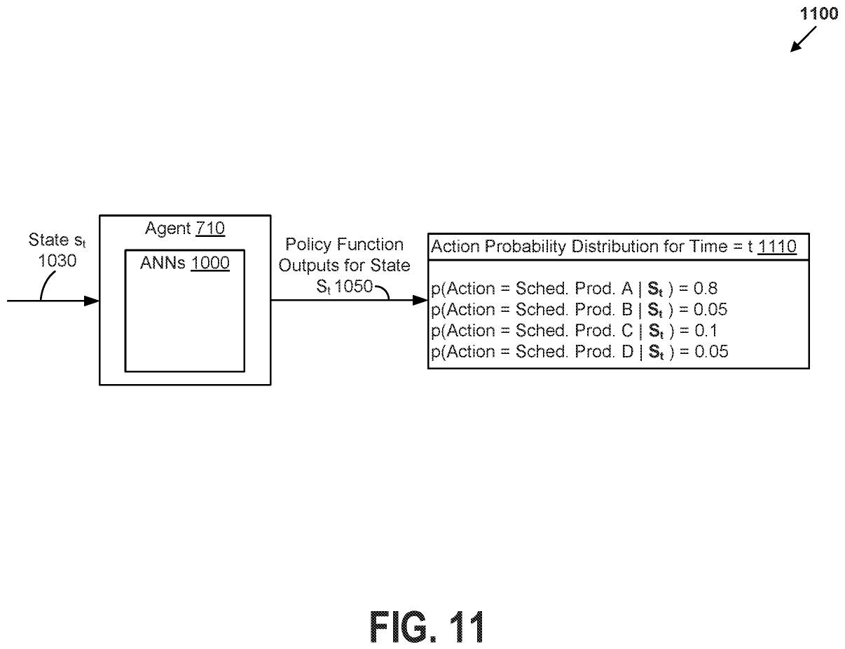

FIG. 12 shows diagram 1200 which illustrates agent 710 generating schedule 1230 based on action probability distributions 1210, in accordance with example embodiments. As the REINFORCE algorithm embodied in agent 710 proceeds through time, multiple action probability distributions 1210 can be obtained for a range of times t₀ to t₁. As illustrated by transition 1220, agent 710 can sample and/or select actions from action probability distributions 1210 for times t₀ to t₁. After sampling and/or selecting actions from action probability distributions 1210 for times t₀ to t₁, agent 710 can generate schedule 1230 for production facility 760 that includes the sampling and/or selecting actions from action probability distributions 1210.

In some examples, a probability distribution for specific actions described by a policy function represented by policy ANN 1020 can be modified. For example, model 800 can represent production constraints that may be present in production facility 760 and so a policy learned by policy ANN 1020 can involve direct interaction with model 800. In some examples, a probability distribution for policy function represented by policy ANN 1020 can be modified to indicate that probabilities of production actions that violate constraints of model 800 have zero probability, thereby limiting an action space of policy ANN 1020 to only permissible actions. Modifying the probability distribution to limit policy ANN 1020 to only permissible actions can speed up training of policy ANN 1020 and can increase the likelihood that constraints will not be violated during operation of agent 710.

Just as constraints may exist for actions described by the policy function, certain states described by a value function represented by value ANN 1010 can be prohibited by operational objectives or physical limitations of production facility 760. These prohibited states can be learned by value ANN 1010 through use of relatively-large penalties being returned for the prohibited states during training, and thereby being avoided by value ANN 1010 and/or policy ANN 1020. In some examples, prohibited states can be removed from a universe of possible states available to agent 710, which speed up training of value ANN 1010 and/or policy ANN 1020 and can increase the likelihood that prohibited states will be avoided during operation of agent 710.

In some examples, production facility 760 can be scheduled using multiple agents. These multiple agents can distribute decision making, and value functions of the multiple agents can reflect coordination required for production actions determined by the multiple agents.

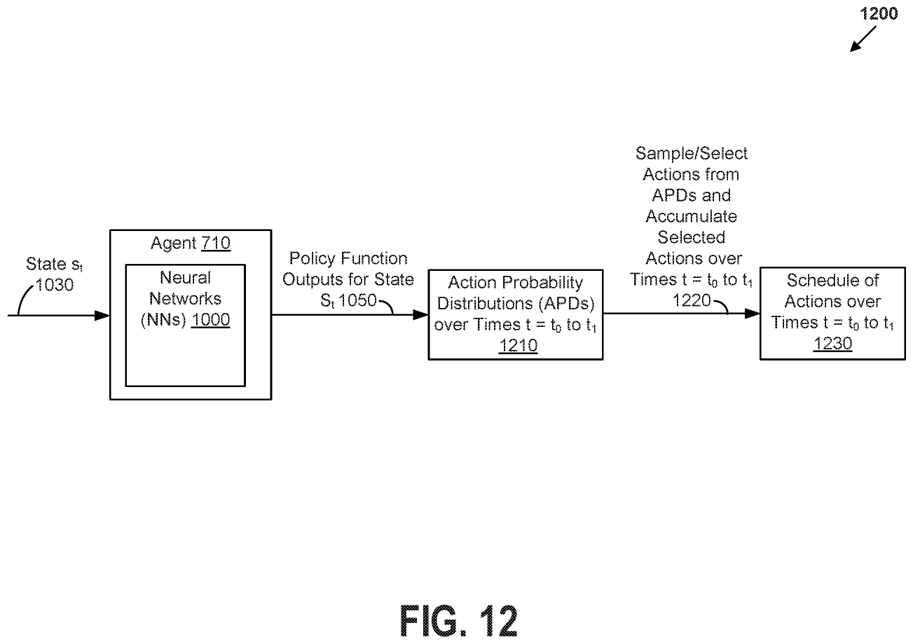

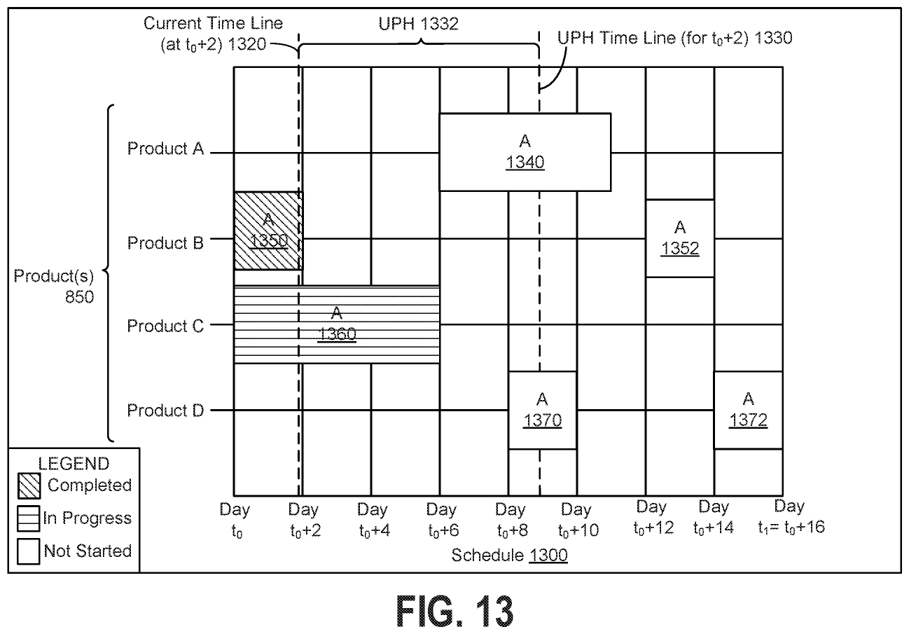

FIG. 13 depicts an example schedule 1300 of actions for production facility 760 being carried out at time=t₀+2, in accordance with example embodiments. In this example, agent 710 generates schedule 1300 for production facility 760 using the techniques for generating schedule 1230 discussed above. Like schedule 900 discussed above, schedule 1300 is based on a receding unchangeable planning horizon of 7 days and uses a Gantt chart to represent production actions.

Schedule 1300 lasts for 17 days for a range of times t₀ to t₁ with t₁=t₀+16 days. FIG. 13 uses current time line 1320 to show that schedule 1300 is being carried out at a time t₀+2 days. Current time line 1320 and unchangeable planning horizon time line 1330 illustrate that unchangeable planning horizon 1332 goes from t₀+2 days to t₀+9 days. Current time line 1320 and unchangeable planning horizon time line 1330 are slightly offset to the left form the respective t₀+2 day and t₀+9 day marks in FIG. 13 for clarity's sake.

Schedule 1300 can direct production of products 850 including Products A, B, C. and D at production facility 760. At t₀+2 days, action 1350 to produce Product B during days t₀ and t₀+1 of has been completed, action 1360 to produce Product C between days t₀ and t₀+5 is in progress, and actions 1340, 1352, 1370, and 1372 have not begun. Action 1340 represents scheduled production of Product A between days t₀+6 and t₀+11, action 1352 represents scheduled production of Product B between days t₀+12 and t₀+14, action 1370 represents scheduled production of Product D between days t₀+8 and t₀+10, and action 1372 represents scheduled production of Product D between days t₀+14 and t₀+16=t₁. Many other schedules for production facility 760 and/or other production facilities are possible as well.

B. Mixed Integer Linear Programming (MILP) Optimization Model

As a basis for comparison of the herein-described reinforcement learning techniques, such as embodiments of the REINFORCE algorithm in a computational agent such as agent 710, both the herein-described reinforcement learning techniques and an optimization model based on MILP were used to schedule production actions at production facility 760 using model 800 over a planning horizon using a receding horizon method.

The MILP model can account for inventory, open orders, production schedule, production constraints and off-grade losses, outages and other interruptions in the same manner as the REINFORCE algorithm used for reinforcement learning described below. The receding horizon requires the MILP model to receive as input not only the production environment, but results from the previous solution to maintain the fixed production schedule within the planning horizon. The MILP model can generate a schedule for 2H time periods to provide better end-state conditions, where H is the number of days in the unchangeable planning horizon; in this example, H=7. Then, the schedule is passed to a model of the production facility to execute. The model of the production facility is stepped forward one time step and the results are fed back into the MILP model to generate a new schedule over the 2H planning horizon.

In particular, Equation 41 is the objective function of the MILP model, which is subject to: the inventory balance constraint specified by Equation 42, the scheduling constraint specified by Equation 43, the shipped orders constraint specified by Equation 44, the production constraint specified by Equation 45, the order index constraint specified by Equation 46, and the daily production quantity constraints specified by Equations 47-51.

$$\begin{matrix}max {\sum }_{n} {\sum }_{l} {\sum }_{i} {\sum }_{t} {α}_{iln} {s}_{itln} - η {\sum }_{i} {\sum }_{t} {β}_{i} {I}_{it} & ( 41 ) \\ s . t . {I}_{it} = {I}_{it - 1} + {p}_{it} - {δ}_{ij} {z}_{ijt} - {\sum }_{n} {\sum }_{l \leq t} {s}_{itln} ∀ i , t & ( 42 ) \\ {z}_{ijt} \geq {y}_{it - 1} + {y}_{jt} - 1 ∀ i , j , t & ( 43 ) \\ {s}_{iltn} = {m}_{n} {x}_{iltn} ∀ n & ( 44 ) \\ {\sum }_{i} {y}_{it} = 1 ∀ t & ( 45 ) \\ {\sum }_{l \leq t} {x}_{itln} = 1 ∀ n & ( 46 ) \\ 0 \leq {p}_{it} \leq {b}_{i}^{max} {y}_{it} ∀ t & ( 47 ) \\ {s}_{iltn} , {I}_{it} , {p}_{it} \geq 0 & ( 48 ) \\ {x}_{iltn} , {y}_{it} , {z}_{ijt} ∈ \{ 0 , 1 \} & ( 49 ) \\ l ∈ \{ 0 , 1 , . . . , t \} & ( 50 ) \\ {α}_{iln} = {α}_{in} ( 1 - \frac{l}{10} ) & ( 51 )\end{matrix}$$

Table 3 below describes variables used in Equations 34-40 associated with the REINFORCE algorithm and Equations 41-51 associated with the MILP model.

TABLE 3
Indices and Sets
i-products index
j-indexes the product immediately following product i
t-time slot index
l-a lateness index, where 1 > 0 indicates a late order
n-individual order index
Variables
pᵢₜ-amount of product i produced at interval t (in MT)
sᵢₜₗₕ-sales of product i at interval t (in MT)
Iᵢₜ-inventory of product i at interval t
xᵢₜₗₙ-tracks shipment of each order
yᵢₜ-product scheduled at interval k.
zᵢⱼₜ-product transition index
δᵢⱼ-transition losses from product i to product j
mₙ-order quantity (in MT)
bₘₐₓⁱ-maximum production quantity (in MT/day)
η- annual working capital cost factor (e.g., 12%)
αₙ-variable standard margin for order n
βᵢ-average variable standard margin for product i
dᵢₗₜₙ-income from a sold order n of product i at interval t

C. Comparison of the REINFORCE Algorithm and the MILP Model

For comparison purposes, both the REINFORCE algorithm embodied in agent 710 and MILP model were tasked with generating schedules for production facility 760 using model 800 over a simulation horizon of three months. In this comparison, each of the REINFORCE algorithm and the MILP model performed a scheduling process each day throughout the simulation horizon, where conditions are identical for both the REINFORCE algorithm and the MILP model throughout the simulation horizon. Both the REINFORCE algorithm and MILP model were utilized to generate schedules that slot products into a production schedule for the simulated reactor for H=7 days in advance, representing a 7 day unchangeable planning horizon within the simulation horizon. During this comparison, the REINFORCE algorithm operates under the same constraints discussed above for the MILP model.

The demand is revealed to the REINFORCE algorithm and MILP model when the current day matches the order entry date that is associated with each order in the system. This provides limited visibility to the REINFORCE algorithm and MILP model of future demand and forces it to react to new entries as they are made available.

Both the REINFORCE algorithm and MILP model were tasked to maximize the profitability of the production facility over the simulation period. The reward/objective function for the comparison is given as Equation 41. The MILP model was run under two conditions, with perfect information and on a rolling time horizon. The former provides the best-case scenario to serve as a benchmark for the other approaches while the latter provides information as to the importance of stochastic elements. The ANNs of the REINFORCE algorithm were trained for 10,000 randomly generated episodes.

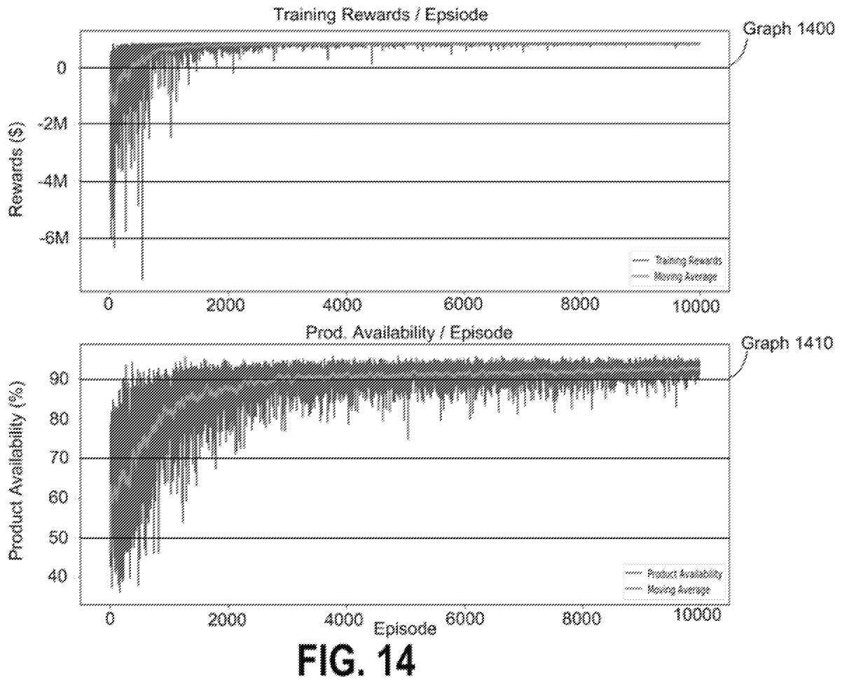

FIG. 14 depicts graphs 1400, 1410 of training rewards per episode and product availability per episode obtained by agent 710 using ANNs 1000 to carry out the REINFORCE algorithm, in accordance with example embodiments. Graph 1400 illustrates training rewards, evaluated in dollars, obtained by ANNs 1000 of agent 710 during training over 10000 episodes. The training rewards depicted in graph 1400 include both actual training rewards for each episode, shown in relatively-dark grey and a moving average of training rewards over all episodes, shown in relatively-light grey. The moving average of training rewards increases during training reaches a positive value after about 700 episodes, and the moving average of average training rewards eventually averages about $1 million ($1M) per episode after 10000 episodes.

Graph 1410 illustrates product availability for each episode, evaluated as a percentage, achieved by ANNs 1000 of agent 710 during training over 10000 episodes. The training rewards depicted in graph 1410 include both actual product availability percentages for each episode, shown in relatively-dark grey, and a moving average of product availability percentages over all episodes, shown in relatively-light grey. The moving average of product availability percentages increases during training to reach and maintain at least 90% product availability after approximately 2850 episodes and the moving average of average training rewards eventually averages about 92% after 10000 episodes. Thus, graphs 1400 and 1410 show that ANNs 1000 of agent 710 can be trained to provide schedules that lead to positive results, both as in terms of (economic) reward and product availability, for production at production facility 760.

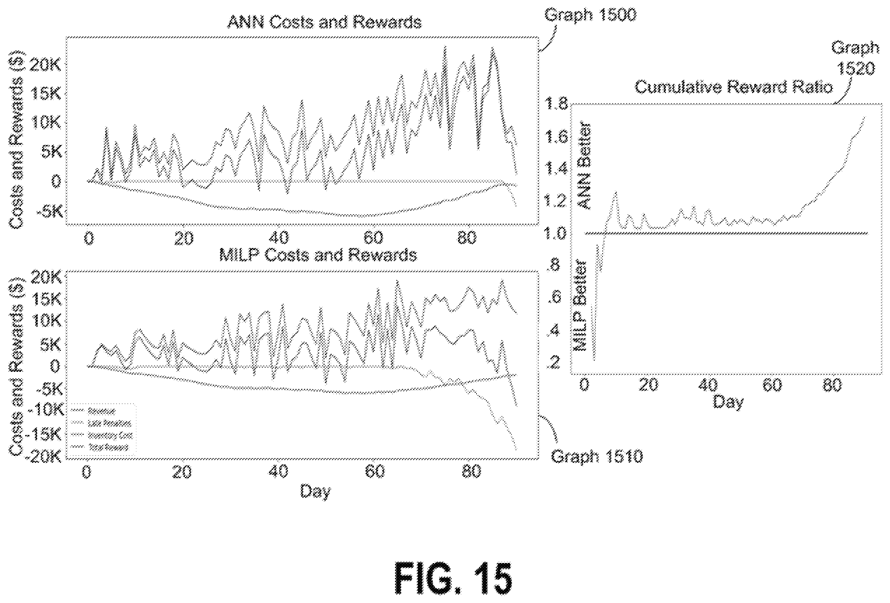

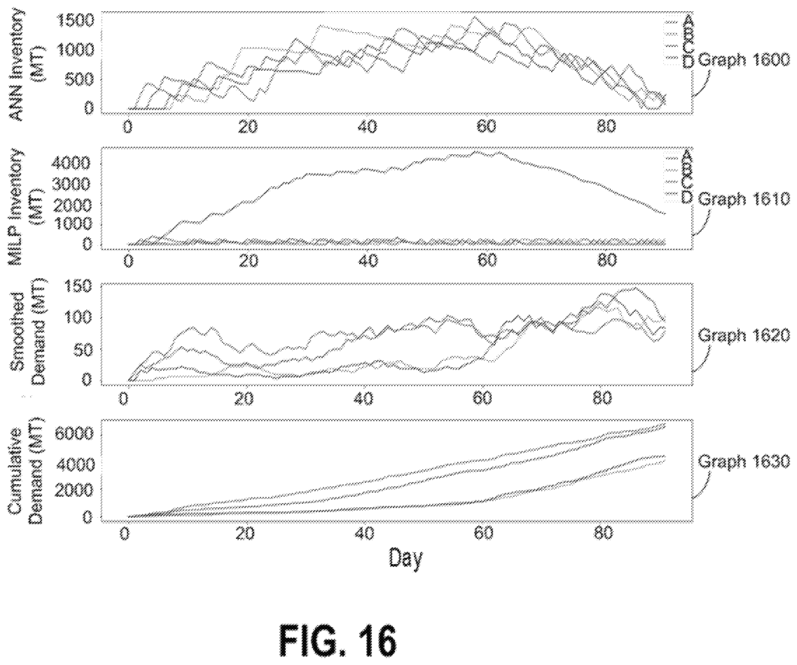

FIGS. 15 and 16 show comparisons of agent 710 using the REINFORCE algorithm with the MILP model in scheduling activities at production facility 760 during an identical scenario, where cumulative demand gradually increases.

FIG. 15 depicts graphs 1500, 1510, 1520 comparing REINFORCE algorithm and MILP performance in scheduling activities at production facility 760, in accordance with example embodiments. Graph 1500 shows costs incurred and rewards obtained by agent 710 using ANNs 1000 to carry out the REINFORCE algorithm. Graph 1510 shows costs incurred and rewards obtained by the MILP model described above. Graph 1520 compares performance between agent 710 using ANNs 1000 to carry out the REINFORCE algorithm and the MILP model for the scenario.

Graph 1500 shows that as cumulative demand increases during the scenario, agent 710 using ANNs 1000 to carry out the REINFORCE algorithm increases its rewards because agent 710 has built up inventory to better match the demand. Lacking any forecast, graph 1510 shows that MILP model begins to accumulate late penalties. To compare performance between agent 710 and the MILP model, graph 1520 shows a cumulative reward ratio of R_{ANN}/R_{MILP} where R_{ANN} is a cumulative amount of rewards obtained by agent 710 during the scenario, and where R_{ANN} is a cumulative amount of rewards obtained by the MILP model during the scenario. Graph 1520 shows that, after a few days, agent 710 consistently outperforms the MILP model on a cumulative reward ratio basis.

Graph 1600 of FIG. 16 shows amounts of inventory of Products A, B, C, and D incurred by agent 710 using ANNs 1000 to carry out the REINFORCE algorithm. Graph 1610 shows amounts of inventory of Products A, B, C. and D incurred by the MILP model. In this scenario, inventory of Products A, B, C, and D reflects incorrect orders, and so larger (or smaller) inventory amounts reflect larger (or smaller) amounts of requested products on incorrect orders. Graph 1610 shows that the MILP model had a dominating amounts of requested Product D, reach nearly 4000 megatons (MT) of inventory of Product D, while graph 1600 shows that agent 710 had relatively consistent performance for all products and that maximum amount of inventory of any one product was less than 1500 MT.

Graphs 1620 and 1630 illustrate demand during the scenario comparing the REINFORCE algorithm and the MILP model. Graph 1620 shows smoothed demand on a daily basis for each of Products A, B, C, and D during the scenario, while graph 1630 shows cumulative demand for each of Products A, B, C, and D during the scenario. Together graphs 1620 and 1630 show that demand generally increases during the scenario, with requests for Products A and C being somewhat larger than requests for Products B and D early in the scenario, but requests for Products B and D are somewhat larger than requests for Products A and C by the end of the scenario. Cumulatively, graph 1630 shows that demand for Product C was highest during the scenario, followed (in demand order) by Product A, Product D, and Product B.

Table 4 below tabulates the comparison of REINFORCE and MILP results over at least 10 episodes. Because of the stochastic nature of the model, Table 4 includes average results for both as well as direct comparisons whereby the two approaches are given the same demand and production stoppages. Average results from 100 episodes are given in Table 4 for the REINFORCE algorithm and average results from 10 episodes are provided for the MILP model. Due to the longer times required to solve the MILP vs. scheduling with the reinforcement learning model, fewer results are available for the MILP model.

Table 4 further illustrates the superior performance of the REINFORCE algorithm indicated by FIGS. 14, 15, and 16. The REINFORCE algorithm converged to a policy that yielded 92% product availability over the last 100 training episodes and an average reward of $748,596. In comparison, the MILP provided a significantly smaller average reward of $476,080 and a significantly smaller product availability of 61.6%.

TABLE 4

| | REINFORCE | MILP | Percentage |
|---|---|---|---|
| Mean Results | (100 Episodes) | (10 Episodes) | Difference |
| Reward | $748,596 | $476,080 | 57.2% |
| Revenue | $842,232 | $785,124 | 7.3% |
| Late Penalties | $9,508 | $214,985 | −95.6% |
| Inventory Cost | $5,729 | $94,059 | −93.9% |
| Product Availability | 92.4% | 61.6% | 50.1% |
| Late Days Per | 99.2 | 1,267 | −92.2% |
| Episode | | | |
| Average Order Delay | 0.11 | 1.45 | −92.2% |

The MILP method was outperformed by the REINFORCE algorithm largely due to the ability for the reinforcement learning model to naturally account for uncertainty. The policy gradient algorithm can learn by determining which action is most likely to increase future rewards in a given state, then selects that action when that state, or a similar state, is encountered in the future. Although the demand differs for each trial, the REINFORCE algorithm is capable of learning what to expect because it follows a similar statistical distribution from one episode to the next.

### IV. EXAMPLE OPERATIONS

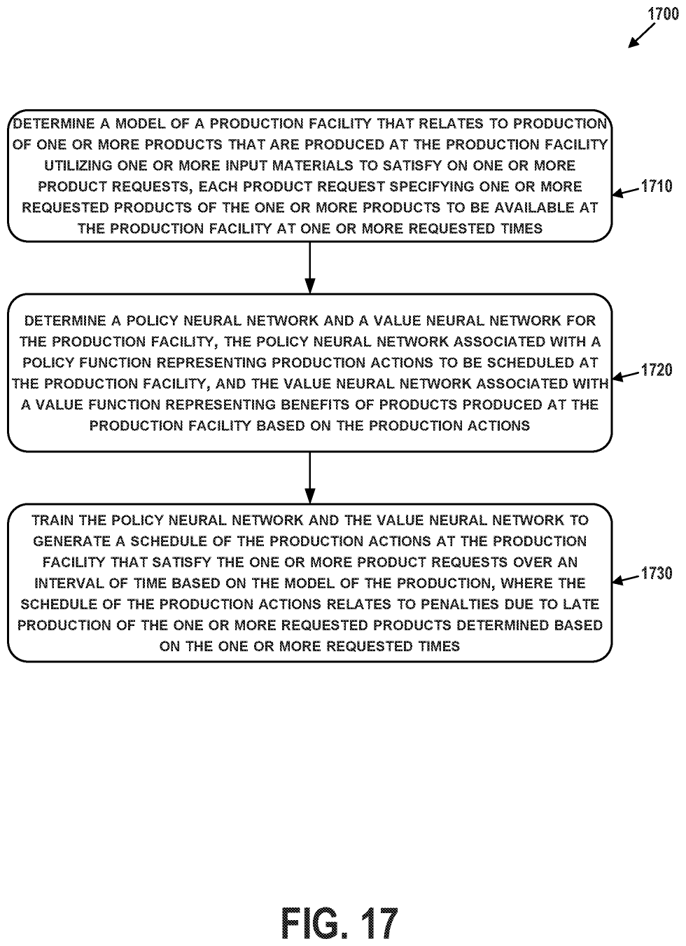

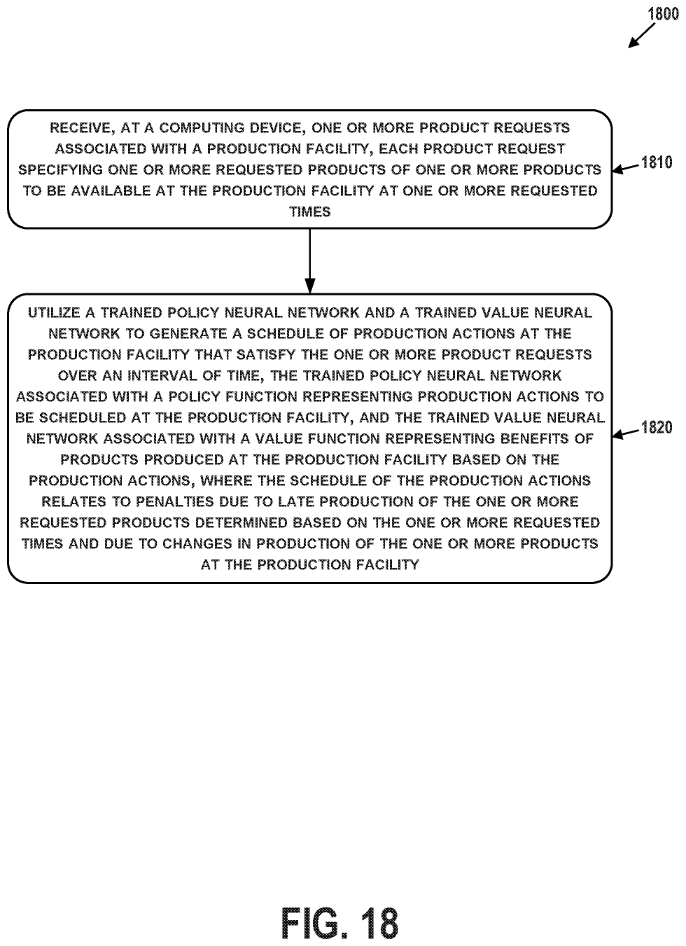

FIGS. 17 and 18 are flow charts illustrating example embodiments. Methods 1700 and 1800, respectively illustrated by FIGS. 17 and 18, can be carried out by a computing device, such as computing device 100, and/or a cluster of computing devices, such as server cluster 200. However, method 1700 and/or method 1800 can be carried out by other types of devices or device subsystems. For example, method 1700 and/or method 1800 can be carried out by a portable computer, such as a laptop or a tablet device.

Method 1700 and/or method 1800 can be simplified by the removal of any one or more of the features shown in respective FIGS. 17 and 18. Further, method 1700 and/or method 1800 can be combined and/or reordered with features, aspects, and/or implementations of any of the previous figures or otherwise described herein.

Method 1700 of FIG. 17 can be a computer-implemented method. Method 1700 can begin at block 1710, where a model of a production facility that relates to production of one or more products that are produced at the production facility utilizing one or more input materials to satisfy one or more product requests can be determined.

At block 1720, a policy neural network and a value neural network for the production facility can be determined, where the policy neural network can be associated with a policy function representing production actions to be scheduled at the production facility, and the value neural network can be associated with a value function representing benefits of products produced at the production facility based on the production actions

At block 1730, the policy neural network and the value neural network can be trained to generate a schedule of the production actions at the production facility that satisfy the one or more product requests over an interval of time based on the model of the production, where the schedule of the production actions relates to penalties due to late production of the one or more requested products determined based on the one or more requested times.

In some embodiments, the policy function can map one or more states of the production facility to the production actions, where a state of the one or more states of the production facility can represent a product inventory of the one or more products available at the production facility at a specific time within the interval of time and an input-material inventory of the one or more input materials available at the production facility at the specific time, and where the value function can represent a benefits of products produced after taking production actions and the penalties due to late production.

In some of these embodiments, training the policy neural network and the value neural network can include: receiving an input related to a particular state of the one or more states of the production facility at the policy neural network and the value neural network; scheduling a particular production action based on the particular state utilizing the policy neural network; determining an estimated benefit of the particular production action utilizing the value neural network; and updating the policy neural network and the value neural network based on the estimated benefit. In some of these embodiments, updating the policy neural network and the value neural network based on the estimated benefit can include: determining an actual benefit for the particular production action; determining a benefit error between the estimated benefit and the actual benefit; and updating the value neural network based on the benefit error.

In some of these embodiments, scheduling the particular production action based on the particular state utilizing the policy neural network can include: determining a probability distribution of the production actions to be scheduled at the production facility based on the particular state utilizing the policy neural network; and determining the particular production action based on the probability distribution of the production actions.

In some of these embodiments, method 1700 can further include: after scheduling the particular production action based on the particular state utilizing the policy neural network, updating the model of the production facility based on the particular production action by: updating the input-material inventory to account for input materials used to perform the particular production action and for additional input materials received at the production facility; updating the product inventory to account for products produced by the particular production action; determining whether at least part of at least one product request is satisfied by the updated product inventory; after determining that at least part of at least one product request is satisfied: determining one or more shippable products to satisfy the at least part of at least one product request; re-updating the product inventory to account for shipment of the one or more shippable products: and updating the one or more product requests based on the shipment of the one or more shippable products.

In some embodiments, training the policy neural network and the value neural network can include: utilizing a Monte Carlo technique to generate one or more Monte Carlo product requests; and training the policy neural network and the value neural network based on the model of the production facility to satisfy the one or more Monte Carlo product requests.

In some embodiments, training the policy neural network and the value neural network can include: utilizing a Monte Carlo technique to generate one or more Monte Carlo states of the production facility, where each Monte Carlo state of the production facility represents an inventory of the one or more products and the one or more input materials available at the production facility at a specific time within the interval of time; and training the policy neural network and the value neural network based on the model of the production facility to satisfy the one or more Monte Carlo states.

In some embodiments, training the neural network to represent the policy function and the value function can include training the neural network to represent the policy function and the value function utilizing a reinforcement learning technique.

In some embodiments, the value function can represent one or more of: economic values of one or more products produced by the production facility, economic values of one or more penalties incurred at the production facility, economic values of input materials utilized by the production facility, an indication of delay in shipment of the one or more requested products, and a percentage of on-time product availability for the one or more requested products.

In some embodiments, the schedule of the production actions can further relate to losses incurred by changing production of products at the production facility, and where the value function represents benefits of products produced after taking production action, the penalties due to late production, and the losses incurred by changing production.

In some embodiments, the schedule of the production actions can include an unchangeable-planning-horizon schedule of production activities during a planning horizon of time, where the unchangeable-planning-horizon schedule of production activities is unchangeable during the planning horizon. In some of these embodiments, the schedule of the production actions can include a daily schedule, and where the planning horizon can be at least seven days.

In some embodiments, the one or more products include one or more chemical products.

Method 1800 of FIG. 18 can be a computer-implemented method. Method 1800 can begin at block 1810, where a computing device can receive one or more product requests associated with a production facility, each product request specifying one or more requested products of one or more products to be available at the production facility at one or more requested times.

At block 1820, a trained policy neural network and a trained value neural network can be utilized to generate a schedule of production actions at the production facility that satisfy the one or more product requests over an interval of time, the trained policy neural network associated with a policy function representing production actions to be scheduled at the production facility, and the trained value neural network associated with a value function representing benefits of products produced at the production facility based on the production actions, where the schedule of the production actions relates to penalties due to late production of the one or more requested products determined based on the one or more requested times and due to changes in production of the one or more products at the production facility.

In some embodiments, the policy function can map one or more states of the production facility to the production actions, where a state of the one or more states of the production facility represents a product inventory of the one or more products available at the production facility at a specific time and an input-material inventory of one or more input materials available at the production facility at a specific time, and where the value function represents benefits of products produced after taking production actions and the penalties due to late production.

In some of these embodiments, utilizing the trained policy neural network and the trained value neural network can include: determining a particular state of the one or more states of the production facility: scheduling a particular production action based on the particular state utilizing the trained policy neural network; and determining an estimated benefit of the particular production action utilizing the trained value neural network.

In some of these embodiments, where scheduling the particular production action based on the particular state utilizing the trained policy neural network can include: determining a probability distribution of the production actions to be scheduled at the production facility based on the particular state utilizing the trained policy neural network; and determining the particular production action based on the probability distribution of the production actions.

In some of these embodiments, method 1800 can further include after scheduling the particular production action based on the particular state utilizing the trained policy neural network: updating the input-material inventory to account for input materials used to perform the particular production action and for additional input materials received at the production facility, updating the product inventory to account for products produced by the particular production action; determining whether at least part of at least one product request is satisfied by the updated product inventory; after determining that at least part of at least one product request is satisfied: determining one or more shippable products to satisfy the at least part of at least one product request; re-updating the product inventory to account for shipment of the one or more shippable products; and updating the one or more product requests based on the shipment of the one or more shippable products.

In some embodiments, the value function can represent one or more of: economic values of one or more products produced by the production facility, economic values of one or more penalties incurred at the production facility, economic values of input materials utilized by the production facility, an indication of delay in shipment of the one or more requested products, and a percentage of on-time product availability for the one or more requested products.

In some embodiments, the schedule of the production actions can further relate to losses incurred by changing production of products at the production facility, and where the value function represents benefits of products produced after taking production action, the penalties due to late production, and the losses incurred by changing production.

In some embodiments, the schedule of the production actions can include an unchangeable-planning-horizon schedule of production activities during a planning horizon of time, where the unchangeable-planning-horizon schedule of production activities is unchangeable during the planning horizon. In some of these embodiments, the schedule of the production actions can include a daily schedule, and where the planning horizon can be at least seven days.

In some embodiments, the one or more products can include one or more chemical products.

In some embodiments, method 1800 can further include: after utilizing the trained policy neural network and the trained value neural network to schedule actions at the production facility, receiving, at the trained neural networks, feedback about actions scheduled by the trained neural networks; and updating the trained neural networks based on the feedback related to the scheduled actions.

### V. CONCLUSION

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid state drive, or another storage medium.

The computer readable medium can also include non-transitory computer readable media such as computer readable media that store data for short periods of time like register memory and processor cache. The computer readable media can further include non-transitory computer readable media that store program code and/or data for longer periods of time. Thus, the computer readable media can include secondary or persistent long term storage, like ROM, optical or magnetic disks, solid state drives, compact-disc read only memory (CD-ROM), for example. The computer readable media can also be any other volatile or non-volatile storage systems. A computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

1. A computer-implemented method, comprising:
determining a model of a production facility that relates to production of one or more products that are produced at the production facility utilizing one or more input materials to satisfy one or more product requests, each product request specifying one or more requested products of the one or more products to be available at the production facility at one or more requested times;
determining a policy neural network and a value neural network for the production facility, the policy neural network associated with a policy function representing production actions to be scheduled at the production facility, and the value neural network associated with a value function representing benefits of products produced at the production facility based on the production actions; and
training the policy neural network and the value neural network to generate a schedule of the production actions at the production facility that satisfy the one or more product requests over an interval of time based on the model of the production, wherein the schedule of the production actions relates to penalties due to late production of the one or more requested products determined based on the one or more requested times.

2. The computer-implemented method of claim 1, wherein the policy function maps one or more states of the production facility to the production actions, wherein a state of the one or more states of the production facility represents a product inventory of the one or more products available at the production facility at a specific time within the interval of time and an input-material inventory of the one or more input materials available at the production facility at the specific time, and wherein the value function represents benefits of products produced after taking production actions and the penalties due to late production.

3. The computer-implemented method of claim 2, wherein training the policy neural network and the value neural network comprises:
receiving an input related to a particular state of the one or more states of the production facility at the policy neural network and the value neural network;
scheduling a particular production action based on the particular state utilizing the policy neural network;
determining an estimated benefit of the particular production action utilizing the value neural network; and
updating the policy neural network and the value neural network based on the estimated benefit.

4. The computer-implemented method of claim 3, wherein updating the policy neural network and the value neural network based on the estimated benefit comprises:
determining an actual benefit for the particular production action;
determining a benefit error between the estimated benefit and the actual benefit; and
updating the value neural network based on the benefit error.

5. The computer-implemented method of claim 3, wherein scheduling the particular production action based on the particular state utilizing the policy neural network comprises:
determining a probability distribution of the production actions to be scheduled at the production facility based on the particular state utilizing the policy neural network; and
determining the particular production action based on the probability distribution of the production actions.

6. The computer-implemented method of claim 3, further comprising:
after scheduling the particular production action based on the particular state utilizing the policy neural network, updating the model of the production facility based on the particular production action by:
updating the input-material inventory to account for input materials used to perform the particular production action and for additional input materials received at the production facility;
updating the product inventory to account for products produced by the particular production action;
determining whether at least part of at least one product request is satisfied by the updated product inventory;
after determining that at least part of at least one product request is satisfied:
determining one or more shippable products to satisfy the at least part of at least one product request;
re-updating the product inventory to account for shipment of the one or more shippable products; and
updating the one or more product requests based on the shipment of the one or more shippable products.

7. The computer-implemented method of claim 1, wherein training the policy neural network and the value neural network comprises:
utilizing a Monte Carlo technique to generate one or more Monte Carlo product requests; and
training the policy neural network and the value neural network based on the model of the production facility to satisfy the one or more Monte Carlo product requests.

8. The computer-implemented method of claim 1, wherein training the policy neural network and the value neural network comprises:
utilizing a Monte Carlo technique to generate one or more Monte Carlo states of the production facility, wherein each Monte Carlo state of the production facility represents an inventory of the one or more products and the one or more input materials available at the production facility at a specific time within the interval of time; and
training the policy neural network and the value neural network based on the model of the production facility to satisfy the one or more Monte Carlo states.

9. The computer-implemented method of claim 1, wherein training the neural network to represent the policy function and the value function comprises training the neural network to represent the policy function and the value function utilizing a reinforcement learning technique.

10. The computer-implemented method of claim 1, wherein the value function represents one or more of: economic values of one or more products produced by the production facility, economic values of one or more penalties incurred at the production facility, economic values of input materials utilized by the production facility, an indication of delay in shipment of the one or more requested products, and a percentage of on-time product availability for the one or more requested products.

11. The computer-implemented method of claim 1, wherein the schedule of the production actions further relates to losses incurred by changing production of products at the production facility, and wherein the value function represents benefits of products produced after taking production action, the penalties due to late production, and the losses incurred by changing production.

12. The computer-implemented method of claim 1, wherein the schedule of the production actions comprises an unchangeable-planning-horizon schedule of production activities during a planning horizon of time, wherein the unchangeable-planning-horizon schedule of production activities is unchangeable during the planning horizon.

13.-18. (canceled)

19. A computer-implemented method, comprising:
receiving, at a computing device, one or more product requests associated with a production facility, each product request specifying one or more requested products of one or more products to be available at the production facility at one or more requested times; and
utilizing a trained policy neural network and a trained value neural network to generate a schedule of production actions at the production facility that satisfy the one or more product requests over an interval of time, the trained policy neural network associated with a policy function representing production actions to be scheduled at the production facility, and the trained value neural network associated with a value function representing benefits of products produced at the production facility based on the production actions, wherein the schedule of the production actions relates to penalties due to late production of the one or more requested products determined based on the one or more requested times and due to changes in production of the one or more products at the production facility.

20. The computer-implemented method of claim 19, wherein the policy function maps one or more states of the production facility to the production actions, wherein a state of the one or more states of the production facility represents a product inventory of the one or more products available at the production facility at a specific time and an input-material inventory of one or more input materials available at the production facility at a specific time, and wherein the value function represents benefits of products produced after taking production actions and the penalties due to late production.

21. The computer-implemented method of claim 20, wherein utilizing the trained policy neural network and the trained value neural network comprises:
determining a particular state of the one or more states of the production facility;
scheduling a particular production action based on the particular state utilizing the trained policy neural network; and
determining an estimated benefit of the particular production action utilizing the trained value neural network.

22. The computer-implemented method of claim 21, wherein scheduling the particular production action based on the particular state utilizing the trained policy neural network comprises:
determining a probability distribution of the production actions to be scheduled at the production facility based on the particular state utilizing the trained policy neural network; and
determining the particular production action based on the probability distribution of the production actions.

23. The computer-implemented method of claim 2, further comprising:
after scheduling the particular production action based on the particular state utilizing the trained policy neural network:
updating the input-material inventory to account for input materials used to perform the particular production action and for additional input materials received at the production facility;
updating the product inventory to account for products produced by the particular production action;
determining whether at least part of at least one product request is satisfied by the updated product inventory;
after determining that at least part of at least one product request is satisfied:
determining one or more shippable products to satisfy the at least part of at least one product request;
re-updating the product inventory to account for shipment of the one or more shippable products; and
updating the one or more product requests based on the shipment of the one or more shippable products.

24. The computer-implemented method of claim 19, wherein the value function represents one or more of: economic values of one or more products produced by the production facility, economic values of one or more penalties incurred at the production facility, economic values of input materials utilized by the production facility, an indication of delay in shipment of the one or more requested products, and a percentage of on-time product availability for the one or more requested products.

25. The computer-implemented method of claim 19, wherein the schedule of the production actions further relates to losses incurred by changing production of products at the production facility, and wherein the value function represents benefits of products produced after taking production action, the penalties due to late production, and the losses incurred by changing production.

26. The computer-implemented method of claim 19, wherein the schedule of the production actions comprises an unchangeable-planning-horizon schedule of production activities during a planning horizon of time, wherein the unchangeable-planning-horizon schedule of production activities is unchangeable during the planning horizon.

27.-33. (canceled)
